(19) United States
(12) Patent Application Publication
(10) Pub. No.: US 2026/0236799 A1
(43) Pub. Date: Aug. 13, 2026

(54) AI AGENT WITH BLUFFING CAPABILITIES IN AN AGENT DECISION PLATFORM

(71) Applicant: QOMPLX LLC, Reston, VA (US)

(72) Inventors: Jason Crabtree, Vienna, VA (US); Richard Kelley, Woodbridge, VA (US); Jason Hopper, Halifax (CA); David Park, Fairfax, VA (US)

(21) Appl. No.: 19/053,400

(22) Filed: Feb. 13, 2025

(51) Int. Cl. G06N 5/025

(52) U.S. Cl. CPC G06N 5/025

(57) ABSTRACT

A system and method for artificial intelligence agents capable of strategic information management in social and professional contexts is disclosed. The system and method combines context-aware decision-making with game theory principles to enable appropriate information disclosure, ranging from simple omission to strategic misdirection. An ethics enforcer ensures communications remain within role-appropriate boundaries, while integrated humor capabilities maintain social grace. A comprehensive audit system provides transparent tracking of all decisions and actions. The invention enables AI agents to effectively represent users across various scenarios—from social interactions to business negotiations—while maintaining ethical boundaries and professional responsibilities, continuously learning and adapting through user feedback and outcome analysis.

### CROSS-REFERENCE TO RELATED APPLICATIONS

Priority is claimed in the application data sheet to the following patents or patent applications, each of which is expressly incorporated herein by reference in its entirety:

None.

### BACKGROUND OF THE INVENTION

### Field of the Art

The present invention relates generally to artificial intelligence systems, and more particularly to AI systems capable of context-aware strategic information management and reasoning with varying degrees of autonomy and delegated authority in social or professional contexts with other humans, robots, other AI agents, or systems.

### Discussion of the State of the Art

In the modern digital interactions, artificial intelligence (AI) agents increasingly represent users, organizations, or entities across various contexts, from advisory roles to business negotiations to social interactions. These AI systems must navigate complex social situations that often require nuanced communication, including strategic information management and social graces. However, current AI systems typically operate with strict adherence to complete truthfulness, limiting their effectiveness in real-world scenarios where humans naturally employ selective disclosure, strategic omission, or tactful misdirection to maximize benefit.

Traditional AI agents at present lack the sophisticated capability to appropriately manage information disclosure in ways that mirror human social intelligence such as for outcome maximization or harm minimization. For instance, they may struggle with simple social situations like politely declining an invitation without revealing disinterest, sharing too many personal details, or navigating complex business negotiations where strategic information management is important to maintain or gain leverage. In fact, in many cases, sharing too much context with an AI agent, e.g., an LLM based version can result in inopportune parroting of confidential material if intentionally targeted or interrogated by others. This limitation becomes particularly apparent in professional contexts where role-specific responsibilities require careful balance between transparency and discretion, such as doctors maintaining patient confidentiality or executives handling sensitive business information or a legal negotiation where clients interest and loyalty, professional responsibility rules and ethical conduct all play a role.

Existing approaches to AI communication tend to follow rigid binary patterns, such as—complete disclosure or pre-programmed evasion, lacking flexibility in real-time contextual adaptation, or leaving such elements to change outputs from an LLM. Current systems prompt or user standing prompt structures are demonstrably inadequate. These systems fail to incorporate the nuanced understanding of social context, relationship dynamics, and situational appropriateness that characterizes human interaction. Furthermore, they lack the ability to integrate humor and social grace into their communication strategies, making their interactions feel rigid and artificial or inappropriate to support intended goals.

Recent advances in game theory, particularly from areas such as poker AI research, have demonstrated the potential for AI systems to better manage incomplete information and strategic interaction more effectively. Additionally, developments in natural language processing and contextual understanding have opened new possibilities for more sophisticated AI-driven communication with other AI agents, people, other AI systems, groups and applications. However, these capabilities have not been successfully integrated into a comprehensive system for AI agents that can represent users in everyday situations requiring tactful information management that also aligns with professional, legal, social responsibilities, and matches intended delegation of authority from a human or organizational entity.

What is needed is an AI system capable of context-aware, ethically-bounded strategic communication that can effectively represent users across various social and professional situations. Such a system should integrate techniques such as advanced game theory principles with social intelligence, while maintaining strict ethical guidelines and comprehensive audit capabilities (e.g., via techniques including but not limited to multi-agent debate, user or group reinforcement learning, neurosymbolic knowledge corpora building and answer or fact checks.) The system should be able to employ strategic information management, including appropriate use of omission, misdirection, and humor, in a way that mirrors human social grace and professional discretion while retaining alignment to originating or prompted outcomes.

### SUMMARY OF THE INVENTION

Accordingly, the inventor has conceived and reduced to practice, an AI agent with bluffing capabilities in an agent decision platform, and the ability to strategically withhold information in an agent decision and coordination platform. The present invention addresses these needs by providing an artificial intelligence system for managing complex social, business, government, public and privacy-related interactions. The system includes a context manager that processes multimodal sensor data, configuration data, and external system information to understand the full scope of any interaction. A sophisticated decision-making system employs at least one agent (sometimes groups of agents), structural causal games and reinforcement learning to determine appropriate communication strategies, while a specialized bluffing subsystem implements these strategies using game theory principles derived from poker AI research.

The invention incorporates multiple safeguards, including an ethics enforcer and content filter that ensure all communications remain within appropriate boundaries based on role, age, priority, and context. These may optionally be implemented within one agent or via specialized agents and an associated agent debate or argument process. A comprehensive audit system, may be optionally implemented using traditional databases or nonvolatile storage or digital ledger technology, maintaining verifiable, tamper-proof records of all decisions and actions. The system's natural language parser and generator, enhanced with contextual humor capabilities, social communication model, and a prescribed or dynamic personality model, ensures communications maintain appropriate social grace while achieving strategic objectives.

This integrated approach allows AI agents to navigate complex social and professional situations—from politely declining invitations to managing sensitive negotiations—while maintaining appropriate ethical boundaries and professional responsibilities. The system's ability to learn from interactions and adapt its strategies through reinforcement learning ensures continuous improvement in its communication capabilities.

In one embodiment, the system may comprise an AI negotiation platform which is a comprehensive system designed to facilitate AI-mediated negotiations between parties through autonomous agents, incorporating both primary negotiating entities and specialized agents (e.g., legal, technical, ethics, and scientific specialists) that can operate either as unified font or in direct specialist-to-specialist interactions, with objectives and preferences being structured into hierarchical preference modeling and multi-objective utility functions that adapt based on negotiation context and constraints. The platform's foundation is built on the Common Agent Language (CAL), a machine-optimized communication protocols featuring standardized semantics, context-aware messaging, and deterministic interpretation mechanisms, enabling efficient agent-to-agent communication without human language constraints. Specialist agents coordinate expertise through hierarchical decision frameworks, ensuring that legal, ethical, and technical knowledge is integrated in a structured manner. Resource management is carefully controlled through allocated processing power, memory constraints, and knowledge access, while fairness is maintained through capability matching and negotiation constraints, ethical guardrails, and behavioral monitoring. The platform actively detects malicious agents behavior using anomaly detection algorithms (such as deep support vector data descriptions, graph neural networks, long short term memory (LSTM) autoencoders, lightweight online detector of anomalies (LODA), or Bayesian networks for anomaly detection trustworthiness scoring, and secure multi-party computation (SMPC) to ensure compliance, transparency, and optimal outcomes. The system supports various pricing models (fixed, dynamic, and hybrid) and includes a sophisticated e-discovery system with configurable access levels and relevance scoring. Security and compliance are ensured through multi-factor authentication, role-based access control, and comprehensive data protection measures, while monitoring and analytics track performance metrics, negotiation success rates, and agreement fairness. The platform's integration capabilities extend to external systems through APIs and protocols, with planned expansions for multi-party negotiations, cross-platform integration, and advanced analytics. The implementation follows strict development standards and deployment considerations, ensuring scalability, performance, and security while maintaining comprehensive audit trails and verification mechanisms. These audit trails would include detailed information on individual agent chain of thought, reasoning, reflection, intermediate responses, and externally accessed data sources (such as databases, web crawlers, etc.) The core innovation lies in its ability to enable fair, efficient negotiations between different types of AI agents while maintaining transparency and auditability, all while supporting various deployment models and specialized agent interactions that can be customized based on the negotiation context and requirements.

According to a preferred embodiment, a computing system AI agents with bluffing capabilities in an agent decision platform, the computing system comprising: one or more hardware processors configured for: receiving and analyzing multimodal inputs; evaluating social, legal, financial, economic, and business contexts to generate a context profile; determining an appropriate information disclosure strategy based on the context profile; training a machine learning model on bluffing, game theory, agent teams or collection strategies and expertise mixtures or routing capabilities, and strategic omission strategies; generating a response that includes a bluff or strategic omission or feigned ignorance or pretend competence based on the context profile; integrating humor and social conventions into generated responses based on the context profile; validating responses against its prescribed configuration, parameter set, and role-based ethical boundaries (or ethical or legal agent judges); generating persisted (and optionally immutable) records of intra-team debate, logic, decisions and outcomes or inter-team engagements or equivalents (e.g., to include warranties and representations made through the engagement); and transmitting validated responses, decision-points, guidance requests, ultimate outcomes for action, acceptance, or comment to users is disclosed.

According to a preferred embodiment, such a system may be used as a fully automated arbitration platform between at least two parties to engage in lieu of, or supervised by, a human arbitrator.

According to a preferred embodiment, a computer-implemented method for an AI agent with bluffing capabilities in an agent decision platform, the computer-implemented method comprising: receiving and analyzing multimodal inputs; evaluating social, legal, and business contexts to generate a context profile; determining an appropriate information disclosure strategy based on the context profile; training a machine learning model on bluffing and strategic omission strategies; generating a response that includes a bluff or strategic omission based on the context profile; integrating humor into generated responses based on the context profile; validating responses against role-based ethical boundaries; generating immutable records of decisions and outcomes; and transmitting validated responses to users, is disclosed.

According to a preferred embodiment, a system for an AI agent with bluffing capabilities in an agent decision platform, comprising one or more computers with executable instructions that, when executed, cause the system to: receive and analyze multimodal inputs; evaluate social, legal, and business contexts to generate a context profile; determine an appropriate information disclosure strategy based on the context profile; train a machine learning model on bluffing and strategic omission strategies; generate a response that includes a bluff or strategic omission based on the context profile; integrate humor into generated responses based on the context profile; validate responses against role-based ethical boundaries; generate immutable records of decisions and outcomes; and transmit validated responses to users, is disclosed.

According to an aspect of an embodiment, the second plurality of federated distributed graph-based systems are assigned subtasks from the plurality of subtasks based on the second plurality of federated distributed graph-based systems'privacy and security settings.

In embodiments utilizing large foundation models—such as GPT variants—the platform optionally incorporates system-level prompts (“system cards”) that define explicit policies and rails for permissible outputs. These prompts, sometimes referred to as foundation model alignment guides, detail boundaries on sensitive topics, maximum levels of misdirection, or mandatory disclaimers. By retaining a reference to these “system cards” as part of a prompt architecture, the invention addresses the insufficiency of generic, one-size-fits-all guardrails: it augments them with domain-specific or user-defined constraints stored in the knowledge graph and enforced by the multi-agent ethics layer. Whenever a bluffing maneuver is considered, the subsystem checks the applicable system card to verify compliance with model-imposed restrictions (e.g., no deceptive content that violates a crucial legal threshold). This ensures synergy between large pretrained models and the invention's specialized, ethically oriented bluffing approach, while also generating a complete audit trail of prompt usage for post hoc review.

### BRIEF DESCRIPTION OF THE DRAWING FIGURES

FIG. 1 is a block diagram illustrating an exemplary system architecture for AI agents with bluffing capabilities in an agent decision platform.

FIG. 2 is a block diagram illustrating an exemplary subsystem for AI agents with bluffing capabilities in an agent decision platform, a bluffing subsystem.

FIG. 3 is a block diagram illustrating an exemplary subsystem for AI agents with bluffing capabilities in an agent decision platform, a decision making system.

FIG. 4 is a block diagram illustrating an exemplary subsystem for AI agents with bluffing capabilities in an agent decision platform, a context manager.

FIG. 5 is a block diagram illustrating an exemplary subsystem for AI agents with bluffing capabilities in an agent decision platform, machine learning training system.

FIG. 6 is a block diagram illustrating exemplary subsystems for AI agents with bluffing capabilities in an agent decision platform, an audit logger, a blockchain subsystem, and an outcome analyzer.

FIG. 7 is a block diagram illustrating an exemplary subsystem for AI agents with bluffing capabilities in an agent decision platform, a humor generator and a natural language generator.

FIG. 8 is a block diagram illustrating an exemplary subsystem for AI agents with bluffing capabilities in an agent decision platform, an ethics enforcer.

FIG. 9 is a flow diagram illustrating an exemplary method for an AI agents with bluffing capabilities in an agent decision platform.

FIG. 10 is a flow diagram illustrating an exemplary method for generating bluffs and omissions with AI agents in an agent decision platform.

FIG. 11 is a flow diagram illustrating an exemplary method for developing context profiles for AI agents in an agent decision platform.

FIG. 12 is a flow diagram illustrating an exemplary method for creating a blockchain leger of past decisions made by AI agents in an agent decision platform.

FIG. 13 is a flow diagram illustrating an exemplary method for enforcing ethical boundaries of AI agents in an agent decision platform.

FIG. 14 is a flow diagram illustrating an exemplary method for generating natural language response by AI agents in an agent decision platform.

FIG. 15 illustrates an exemplary computing environment on which an embodiment described herein may be implemented.

FIG. 16 is a block diagram illustrating an exemplary subsystem of the agent team architecture representing a sophisticated multi-layered system for AI-powered negotiations and decision-making process.

FIG. 17 is a block diagram illustrating an exemplary architecture for a cross-agent validation architecture representing a sophisticated system for ensuring the accuracy and reliability of AI decisions through multiple layers of verification and validation.

FIG. 18 is a flow diagram illustrating an exemplary method for an internal debate flow that incorporates the approach to AI decision-making that helps surface truth and exposes potential mistakes.

FIG. 19 illustrates the ergodicity-aware modeling and signaling (EAMS) subsystem with its integrated reflexivity-enhanced self-audit mechanism (RESAM).

### DETAILED DESCRIPTION OF THE INVENTION

The inventor has conceived and reduced to practice an AI agent with bluffing capabilities in an agent decision platform.

The AI agent with bluffing capabilities operates as an integrated decision platform that enables strategic information management across social and professional contexts while maintaining strict ethical boundaries. The platform processes multimodal inputs through sophisticated sensors that detect subtle cues like facial micro-expressions and voice tone variations, while simultaneously incorporating data from external systems including legal databases, negotiation platforms, and e-commerce systems. This rich contextual information feeds into a context manager that builds comprehensive situational profiles through specialized analyzers for social, legal, business, and privacy dimensions. The platform's strategic capabilities center on its unique bluffing subsystem, which implements game theory models derived from poker AI research. These models may use Bayesian belief manipulation and counterfactual reasoning to calculate optimal information disclosure strategies, similar to how advanced poker AI systems evaluate hand strength and position. The system's decision-making process is guided by structural causal games that model potential outcomes while staying within ethical boundaries defined by role-based rules and professional requirements stored in a sophisticated knowledge graph.

Natural language generation capabilities, enhanced with contextually appropriate humor, enable the system to deliver strategic communications while maintaining social grace. All decisions and actions are recorded through an audit system that can optionally implement blockchain technology for immutable record-keeping, and a messaging facility for human in the loop communication. The platform continuously learns and adapts through a machine learning training subsystem that refines strategies based on outcomes, feedback, or new external information. Throughout all operations, an ethics enforcer ensures compliance with professional standards and role-appropriate behavior by referencing a comprehensive framework of legal, medical, business, and social norms encoded in the knowledge graph or other rule encoding framework (e.g., persisting Datalog, Varalog, dyadic existential rules, Datalog with fuzzy logic via arbitrary t-norms, etc.).

In some embodiments, the invention further leverages an extensible plugin architecture to seamlessly incorporate domain-specific knowledge bases (open or proprietary), specialized heuristics, and compliance rule sets by loading a domain declaration to speed integration via integrated ontology mappings. Each plugin module, once registered, can be dynamically loaded into the multi-agent environment to address new industry-specific requirements—such as advanced tax regulations, international arbitration rules, healthcare privacy mandates, or emerging AI ethics guidelines. The plugin's metadata integrates with the knowledge graph, informing the ethics enforcer about any unique constraints or disclaimers needed in tat domain. This modular design allows the system to expand its capabilities far beyond card-based game-play or single-domain fine-tuning, ensuring the bluffing system can operate effectively in diverse real-world negotiations and regulated environments without the combinatorial limitations observed in single-purpose poker solvers.

Additional agent training may occur based on an automated trigger, signal from a system component, or a user. This may be given to one party in the negotiation, all parties, or a party supervising (e.g., digital judge, arbitrator, or overseer). In one embodiment, it may reflect new facts allowed into the negotiation or proceedings, in another, it might be the addition or removal of a party (e.g., witness, plaintiff, defendant), in another, it might relate to other changes in applicable law (e.g., venue and corresponding legal framework, or new applicable legislation signed into law). Training, fine-tuning, or knowledge augmentation may occur for all or some agents participating in a collection both intra and inter party. The training may employ a mix of open, private, or limited access data. It may also include additions manually prescribed scenarios, agents, or a series of generated ones. It may also seek to test the actual sophistication of an agent that is submitted to the negotiation system (e.g., too strong to meet guidance or representations). Agents may explore, compete, and survive in this platform utilizing adversarial, reinforcement, or supervised training methods. Agents may be forced into a series of adversarial scenarios while an orchestration system performs an evolutionary search using a selected agent population. Moreover, the platform supports continuous feedback loops with authorized users or domain experts (or external AI applications or business applications) during multi-stage negotiations. At configurable intervals or on an event oriented basis, the system queries human stakeholders—such as compliance officers, legal counsel, or senior executives—for direct feedback or corrections as individuals or in a group. Feedback data may include newly discovered conflicts, missed factual points, or changed ethical boundaries. This feedback is then stored in an audit logger and optionally leveraged to retrain or fine-tune local agent models, impact rule sets, symbolic reasoning logic, structured expert judgment weightings, additional means of model blending, consensus, verification, or explainability elements. As a result, the invention preserves transparency and alignment with real-time user oversight, ensuring that strategic omissions or misrepresentations remain consistently tethered to validated business, regulatory, or ethical frameworks. This stands in clear contrast to static poker benchmarks, which typically rely on fixed datasets and do not integrate dynamic human-in-the-loop validation or compliance gates.

The Dynamic Agent Training and Evaluation System represents a revolutionary approach to AI agent development, drawing inspiration from competitive evaluation platforms like Chatbot Arena while extending beyond simple head-to-head comparisons. The system implements sophisticated training triggers that can be activated through multiple channels: automated performance monitoring, system component signals, or direct user intervention. These triggers function similarly to how Chatbot Arena identifies and ranks AI capabilities, but with a specific focus on negotiation competencies. When a trigger is activated, whether due to performance thresholds being breached or new scenarios being detected, the system can initiate targeted training for specific agents or implement system-wide updates, much like how AI companies continuously refine their models based on Chatbot Arena's feedback mechanisms. The training distribution follows a nuanced approach, allowing for selective enhancement of individual parties or universal updates affecting all participants. This mirrors the way companies like OpenAI, Google, and Meta use Chatbot Arena's rankings to identify areas for improvement and deploy targeted updates. The system incorporates various training conditions, including the introduction of new evidence, changes in party composition, and updates to legal frameworks. These conditions are processed through a sophisticated methodology that integrates multiple data sources, ranging from open-source repositories to proprietary knowledge bases, similar to how modern AI models are evaluated against diverse benchmarks and real-world scenarios.

The training platform itself operates as a competitive environment, implementing tournament-style evaluations reminiscent of Chatbot Arena's head-to-head format. This includes round-robin tournaments, league-style rankings, and elimination contests, all designed to continuously assess and improve agent capabilities. The system employs various training methods, including adversarial training, reinforcement learning, and supervised learning, while also incorporating evolutionary mechanisms that allow for population-based training and neural architecture search. This approach is particularly relevant given how companies like Google and OpenAI have used Chatbot Arena to test experimental versions of their technologies before public release.

Quality assurance is maintained through comprehensive monitoring systems that track real-time performance, historical trends, and comparative analyses. This is similar to how Chatbot Arena has become a trusted benchmark for AI capability assessment, with its transparent evaluation methodology and clear performance metrics. The system also ensures compliance verification across regulatory, ethical, and legal frameworks, while conducting thorough impact assessments on negotiation outcomes, resource efficiency, and user satisfaction. Integration systems handle the complex task of connecting various data sources and managing workflows, much like how Chatbot Arena has evolved to handle multiple AI models and evaluation criteria while maintaining data integrity and user privacy.

This comprehensive approach ensures that AI agents can continuously improve their negotiation capabilities while maintaining fairness and transparency, similar to how Chatbot Arena has helped establish clear benchmarks for general AI capabilities. The system's ability to adapt and evolve based on real-world feedback and performance metrics makes it particularly valuable in the rapidly advancing field of AI development, where continuous improvement and competitive evaluation have become key drivers of progress.

This integrated approach enables AI agents to effectively represent users across various scenarios—from sensitive negotiations to social interactions—while maintaining appropriate ethical boundaries and professional standards. The system's ability to balance strategic objectives with social grace and professional responsibility, while maintaining clear accountability through comprehensive audit trails, makes it particularly valuable in regulated professional contexts where both effective communication and strict compliance are essential.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Conceptual Architecture

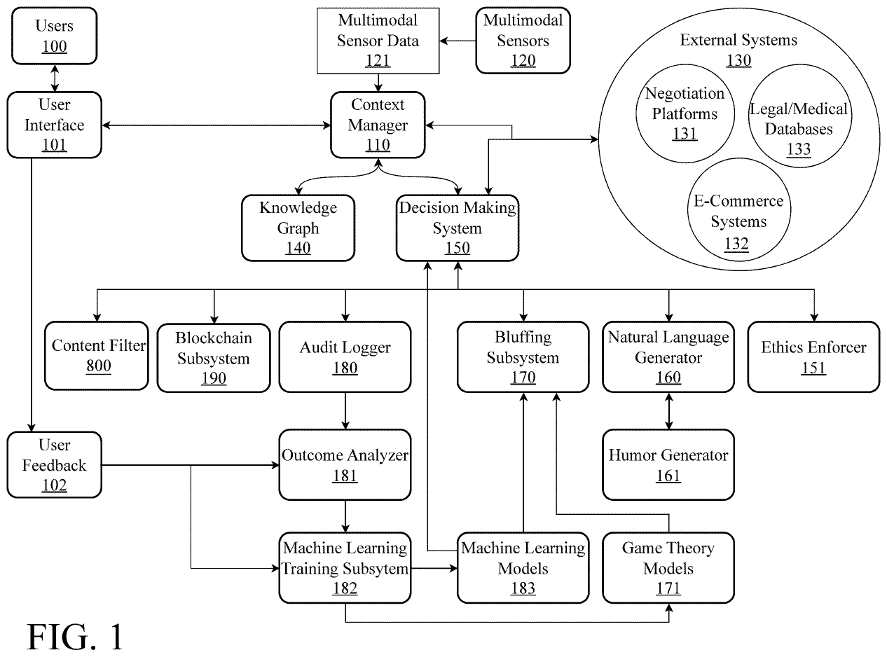

FIG. 1 is a block diagram illustrating an exemplary system architecture for AI agents with bluffing capabilities in an agent decision system. The system comprises multiple interconnected components that work together to enable context-aware, ethical information management by AI agents. Each component serves specific functions while maintaining continuous communication with other system elements to ensure coordinated, effective operation.

Users 100 represent the primary actors interacting with the system. These may include but are not limited to individuals requiring assistance with social interactions, business professionals engaging in negotiations, or service providers (such as doctors, lawyers, or executives) needing to manage sensitive communications. Users interact with the system through a user interface 101, which provides multiple interaction modalities and collects user feedback 102. User interface 101 may be implemented through various means, including but not limited to mobile applications, web interfaces, voice interfaces, or integrated professional software systems. User feedback mechanisms are designed to capture both explicit feedback (such as direct ratings or corrections) and implicit feedback (such as user engagement patterns or response times).

A context manager 110 serves as the central processing hub for environmental and situational awareness. Context manager 110 integrates multiple data streams to build a comprehensive understanding of the current interaction context. Context manager 110 receives input from multimodal sensors 120 that provide multimodal sensor data 121. These sensors may include but are not limited to cameras for facial expression analysis, microphones for tone detection, physiological sensors for emotional state assessment, and environmental sensors for detecting physical context.

In some embodiments, the platform is configured to orchestrate and manage multiple specialized agents operating in parallel, each possessing distinct domain expertise, negotiation styles, or role-based functions. These specialized agents may include, for example (i) a legal compliance agent monitoring regulations and ensuring contractual language adheres to jurisdictional requirements; (ii) a financial analyst agent modeling cost-benefit analyses, discount rates, or risk adjusted valuations; (iii) an ethics agent strictly enforcing moral and professional conduct parameters; (iv) a technical specialist agent verifying operational feasibility or design constraints; and (v) a social dynamics agent focusing on subtle interpersonal cues, trust calibration, and rapport-building strategies. Each agent interacts within an agent coordination layer that enforces standardized communication protocols (e.g., message-passing interface) and ensures data consistency.

These agents may autonomously instantiate or “spun up” by the system in response to contextual triggers derived from the context manager. For instance, if the system detects a negotiation with medically sensitive issues, a healthcare-law agent may be automatically launched to oversee the Health Insurance Portability and Accountability Act (HIPAA) compliance. If advanced technical certifications or safety regulations are implicated, a regulatory check agent with domain-specific rule sets (e.g., Occupational Safety and Health Administration (OSHA) guidelines) could be created. The platform's orchestration subsystem assigns responsibilities to each specialized agent based on rules in the knowledge graph, referencing agent skill sets, prior performance metrics, or user-configured policy settings. The modular approach promotes scalability and adaptability, allowing the system to be rapidly tailored to new industries or unforeseen negotiation contexts with minimal modifications to the core architecture.

Multimodal sensors 120 may be designed to capture subtle social cues that humans naturally process during interactions. For example, facial expression analysis can detect micro-expressions indicating discomfort or disagreement, while tone analysis can identify subtle changes in voice that might suggest skepticism or interest. This granular detection of social signals enables the system to adjust its communication strategies in real-time, similar to how humans modify their approach based on non-verbal feedback.

The system maintains connections with external systems 130, including but not limited to specialized platforms and databases that provide domain-specific information and functionality. Negotiation platforms 131 might include customer relationship management systems, procurement platforms, or dedicated negotiation software that provides historical transaction data and market intelligence. E-commerce systems 132 integration enables the system to understand pricing dynamics, inventory levels, and market conditions that might influence strategic communications. Legal and medical databases 133 provide regulatory frameworks and professional guidelines that govern information disclosure in regulated industries.

A knowledge graph 140 serves as the system's semantic memory and reasoning framework. This graph structure maintains complex interconnections between entities, relationships, roles, responsibilities, and context-specific rules. Knowledge graph 140 enables the system to understand and navigate intricate social and professional networks while maintaining appropriate boundaries and protocols. It stores information about relationship histories, trust levels, professional hierarchies, and domain-specific knowledge that influences communication strategies.

A decision making system 150 represents the cognitive core of the architecture, processing inputs from multiple sources to determine appropriate communication strategies. Working in conjunction with an ethics enforcer 151 and a content filter 800, this system ensures all actions align with ethical guidelines while remaining effective for the given context. Ethics enforcer 151 implements strict boundaries based on professional responsibilities, legal requirements, and ethical principles, while content filter 800 ensures all communications remain appropriate for the specific audience and context.

A natural language generator 160 works in connection with a humor generator 161 and a bluffing subsystem 170 to produce contextually appropriate communications that balance strategic objectives with social grace. Natural language generator 160 transforms strategic decisions into natural, conversational language, while humor generator 161 integrates appropriate levity and social warmth when contextually beneficial. This combination enables the system to maintain engaging, natural interactions even while managing strategic information disclosure.

Bluffing subsystem 170 implements information management strategies derived from game theory principles. Operating within strict ethical boundaries established by ethics enforcer 151, this subsystem utilizes a plurality of game theory models 171 to determine optimal strategies for information disclosure, omission, or strategic misdirection. The game theory models may incorporate principles from poker AI research, enabling the system to manage incomplete information scenarios effectively while maintaining ethical constraints and professional responsibilities.

The system maintains comprehensive tracking and analysis capabilities through an audit logger 180 and an outcome analyzer 181. Audit logger 180 creates detailed records of all system decisions and actions, providing transparency and accountability. Outcome analyzer 181 evaluates the effectiveness of different strategies, feeding this information into a machine learning training subsystem 182. This training subsystem continuously refines the system's machine learning models 183, enabling ongoing improvement in strategy selection and execution.

A blockchain subsystem 190 provides an optional enhancement to the system's audit capabilities. By leveraging distributed ledger technology, this subsystem can create immutable records of decisions and actions, particularly valuable in professional contexts where accountability and auditability are important. The blockchain implementation can be configured for various consensus mechanisms and privacy levels, depending on the specific requirements of the deployment context. To ensure accountability for each strategic action, including any form of bluff or omission, the system generates immutable audit trails for every intra-agent proposal, role-based validation, and final decision output. To ensure accountability for each strategic action—including any form of bluff or omission—the system generates immutable audit trails for every intra-agent proposal, role-based validation, and final decision output. In one embodiment, these logs may be recorded on a blockchain or a tamper-proof distributed ledger, containing cryptographic hashes of all communication steps and associated agent rationale. This design allows third-party auditors, oversight committees, or internal compliance teams to retrospectively examine the sequence of events leading to a specific disclosure or omission. By offering transparent and verifiable documentation of decision-making processes, the invention provides a robust layer of accountability not addressed in poker-oriented benchmarks, where moves are tracked but rarely subjected to domain-specific legal or ethical scrutiny.

The system's components work together seamlessly to enable sophisticated information management across diverse scenarios. For example, in a business negotiation context, the system might receive input from multimodal sensors about counterparty reactions, cross-reference this with historical data from negotiation platforms, apply game theory models to determine optimal information disclosure strategies, and generate appropriate responses that include subtle humor to maintain positive rapport. Throughout this process, the ethics enforcer ensures all communications remain within professional boundaries, while the audit logger maintains detailed records of all decisions and their rationale.

The machine learning components of the system enable continuous improvement through experience. Outcome analyzer 181 evaluates the effectiveness of different strategies across various contexts, while the machine learning training subsystem updates models based on this analysis. This creates a feedback loop that progressively enhances the system's ability to manage complex social and professional interactions while maintaining appropriate ethical boundaries and professional standards.

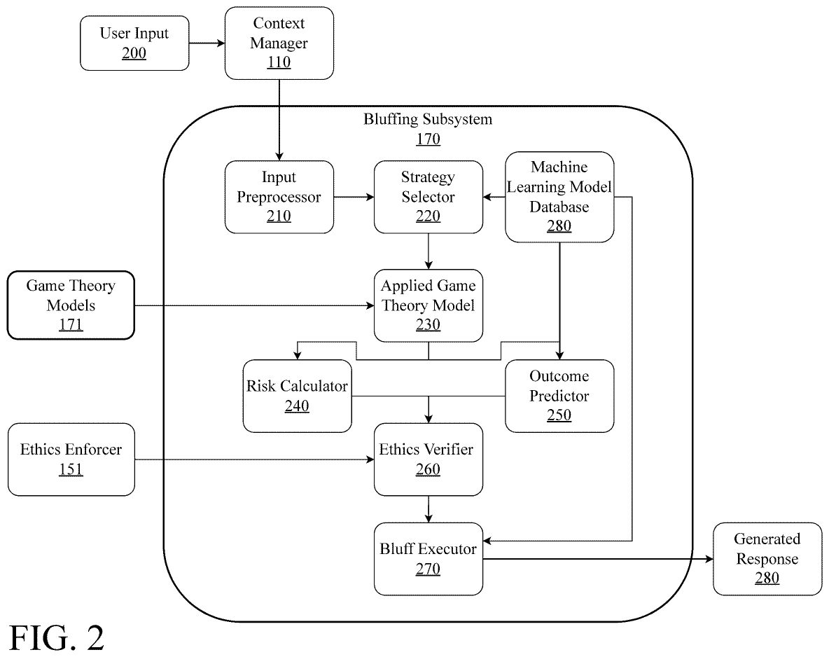

FIG. 2 is a block diagram illustrating an exemplary subsystem for AI agents with bluffing capabilities in an agent decision system, a bluffing subsystem. This subsystem represents the core strategic information management capability of the invention, implementing sophisticated decision-making processes for controlled information disclosure.

Bluffing subsystem 170 receives a user input 200 and context information from the context manager 110, which feed into an input preprocessor 210. The input preprocessor analyzes and structures the incoming data, preparing it for strategic analysis. This preprocessing stage may include parsing of user intentions, contextual parameters, and environmental factors that might influence strategy selection.

A strategy selector 220 evaluates the processed input to determine appropriate strategic approaches. Given the selected strategic approach, a game theory model 230 may be selected to aid in generated an optimal response for the given information in the current context. The applied game theory model in one embodiment may incorporate principles from poker AI research and other game theory frameworks, enabling reasoning about incomplete information scenarios and strategic interaction.

Game theory models 230 aid the platform in implementing its decision-making frameworks derived from poker AI research. When bluffing subsystem 170 receives input through its input preprocessor 210, it engages the game theory models through the strategy selector 220. Strategy selector 220 queries the game theory models for optimal approaches based on the current context, similar to how poker AI systems evaluate hand strength and position. For example, when determining whether to reveal pricing information during a negotiation, the strategy selector uses the game theory models to calculate optimal information disclosure ratios and timing.

The applied game theory model 230 processes these queries by evaluating the current state against learned patterns stored in machine learning model database 280. Working in conjunction with risk calculator 240 and outcome predictor 250, the models determine specific elements of information to withhold or reveal. For instance, in a business negotiation scenario, the system might calculate that revealing 70% of the available budget information while strategically withholding timing constraints will create optimal negotiating leverage. These calculations consider both immediate tactical advantages and long-term strategic implications, similar to how poker AI systems balance immediate pot odds against long-term strategic position.

The applied game theory model 230 may implement both Bayesian belief manipulation and counterfactual reasoning approaches. Through Bayesian belief manipulation, the system continuously estimates how others perceive its actions and adjusts its strategy accordingly. For instance, if multimodal sensors 120 detect skepticism during a negotiation, the system might adjust its disclosure strategy in real-time. In one embodiment, a counterfactual reasoning component, based on DeepStack architecture referenced in the disclosure, may enable the system to simulate “what if” scenarios about revealing or withholding specific information, working with risk calculator 240 and outcome predictor 250 to evaluate potential consequences.

In one embodiment, bluff executor 270 uses reinforcement learning principles to optimize bluffing strategies over time through machine learning training subsystem 182. This approach allows the system to learn from repeated interactions, similar to how poker AI systems optimize their strategies through self-play. When generating a response 280, the executor balances Game Theory Optimal principles of non-exploitability with exploitation of detected patterns in counterparty behavior, all while remaining within boundaries verified by the ethics verifier 260. Each interaction is logged by audit logger 180, creating a feedback loop that enables continuous refinement of the game theory models'parameters and predictions. A further enhancement lies in the system's opponent or counterparty modeling for more nuanced bluffing and selective disclosure. Rather than adhering to a single equilibrium strategy—such as Game Theory Optimal (GTO) poker—the platform tailors bluff frequencies, bet sizing (in a poker context), or withholding tactics according to real-time assessments of a negotiating partner's risk tolerance, aggression level, or perceived trustworthiness. This individualized adaptation is modulated by an Ethics and Compliance Layer that constrains or overrides high-exploitation strategies when they conflict with legal or moral duties. Consequently, the system dynamically balances opportunistic strategic gains against user-mandated guidelines, surpassing the purely zero-sum or purely exploitative focus of most poker-based AI studies.

To bolster the invention's alignment with legal and ethical standards, a Hierarchical Ethics and Compliance Validation Layer can be added. This layer operates at two levels: Local Validation (within individual specialized agents) and Global Validation (across the entire agent team). First, each specialized agent integrates a lightweight, domain-specific rule-checking microservice—e.g., for privacy, securities regulations, or healthcare compliance—ensuring that initial proposals do not conflict with the agent's specialized constraints. Next, before any multi-agent decision is finalized, the Global Validation service consolidates the partial validations, identifies potential conflicts among specialized agents (for example, a strategy that maximizes revenue but contravenes data privacy rules), and resolves them via an internal consensus protocol.

Such a consensus protocol can be realized through an automated Debate Flow featuring a neutral “Arbiter Agent” that weighs contradictory rulings or red flags raised by local validators. The Arbiter Agent queries the Knowledge Graph for hierarchical prioritizations—e.g., certain mandatory legal constraints may override discretionary business preferences—and issues a final pass/fail determination. Audit records of these debate sessions, including any weigh-in by specialized ethics or legal agents, are immutably stored in the Blockchain Subsystem or similar tamper-proof ledger. This two-tier validation system ensures that no single agent's oversight compromises the entire negotiation outcome and that ethically questionable moves are rigorously vetted before execution.

The models integrate with machine learning training subsystem 182 and machine learning models 183, enabling bluff executor 270 to refine its execution strategies based on historical outcomes. When generating a response 280, the executor uses the game theory models'output to structure information disclosure in a way that maintains strategic advantage while staying within ethical boundaries as verified by ethics verifier 260. The entire process is logged by audit logger 180 to enable outcome analysis and strategy refinement. This tight integration between the game theory models and bluffing subsystem components ensures that theoretical strategic insights are effectively translated into practical communication strategies.

A risk calculator 240 works in conjunction with an outcome predictor 250 to evaluate potential risks and consequences of different strategic options. The risk calculator assesses various factors including reputational risk, relationship impact, and potential downsides of strategic choices. The outcome predictor simulates likely outcomes of different strategic approaches, considering both immediate and longer-term consequences. An ethics verifier 260 interfaces with the system's ethics enforcer 151 to ensure all proposed strategies align with ethical guidelines and professional responsibilities. This verification process considers role-specific requirements, legal obligations, and social norms to maintain appropriate boundaries in all communications.

Upon ethical verification, a bluff executor 270 implements the selected strategy, generating a response 280 that achieves strategic objectives while maintaining appropriate social grace and professional standards. The executor draws upon the machine learning model database 280 to refine its execution based on learned patterns and previous outcomes. This architecture enables sophisticated yet responsible information management across various contexts, from simple social interactions to complex professional negotiations. The system maintains strict ethical boundaries while implementing effective strategic communication, continuously learning and adapting through its machine learning components. The disclosed bluffing subsystem harnesses a hybrid computational pipeline integrating statistical (e.g., deep neural networks), symbolic (e.g., rule-based inference), and neuro-symbolic modules to orchestrate strategic misdirection, omissions, or disclosures. Unlike purely data-driven or rule-based models, this subsystem fuses domain knowledge (e.g., contractual directives, professional ethics) encoded in a domain-specific knowledge graph with deep learning-based embedding vectors derived from multi-level sensor inputs. To further ensure contextual alignment and maintain ethical obligations, deontic logic constructs (including normative operators such as “obliged,” “permitted,” and “forbidden”) are leveraged to evaluate candidate bluff actions against role-based or situational norms. For instance, if a proposed bluff might contravene fiduciary responsibilities or conflict with organizational guidelines, the system marks that action as “forbidden,” automatically backtracking to identify permissible alternatives. In doing so, bluffing subsystem 170 can finely regulate the degree and style of misdirection, dynamically adapting to new real-time signals and evolving constraints, thus delivering a strategically potent yet ethically compliant communication strategy.

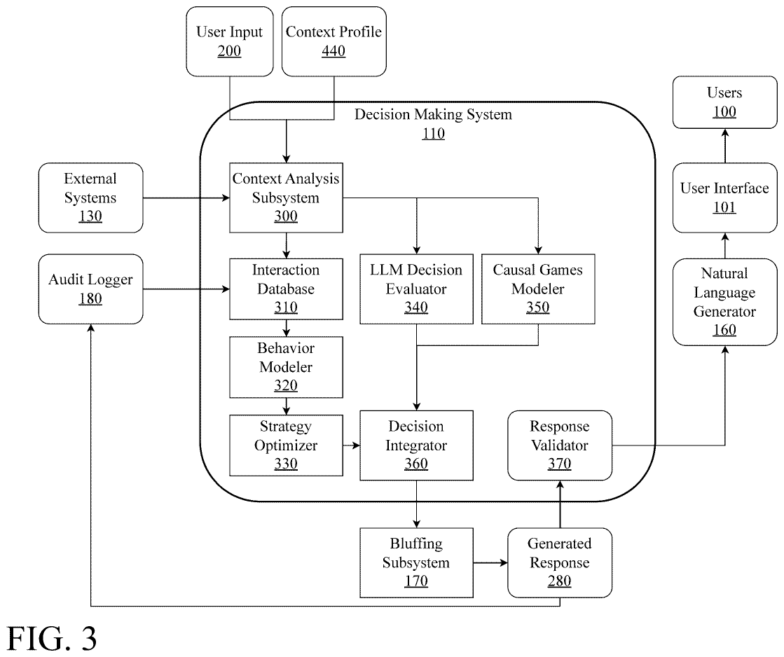

FIG. 3 is a block diagram illustrating an exemplary subsystem for AI agents with bluffing capabilities in an agent decision system, a decision making system. The decision making system 150 receives user input 200 through the user interface 101 from users 100, which initiates the decision-making process. This input, combined with information from external systems 130, feeds into a context analysis subsystem 300. Context analysis subsystem 300 processes this information in conjunction with historical data stored in the interaction database 310, building a comprehensive understanding of the current situation and its requirements.

A behavior modeler 320 works with the strategy optimizer 330 to understand patterns of interaction and determine optimal approaches. Behavior modeler 320 analyzes interaction patterns and relationship dynamics, while strategy optimizer 330 evaluates different strategic options based on past performance and current objectives. These components feed their analysis into two additional subsystems, an LLM decision evaluator 340 and the causal games modeler 350.

LLM decision evaluator 340 processes previous decisions and their outcomes, using large language model capabilities to understand interaction patterns and their consequences. Causal games modeler 350 implements structural causal games to model decision paths and predict outcomes, ensuring the system's decisions align with expected results while maintaining ethical boundaries.

A decision integrator 360 synthesizes inputs from these various components to formulate a coherent strategy. This integrated decision then flows to the bluffing subsystem 170 for tactical implementation when appropriate. In one embodiment a generated response 280 passes through a response validator 370 before being processed by natural language generator 160 for final delivery.

Throughout this process, the system maintains a detailed context profile 440 and logs all decisions and actions through the audit logger 180. This comprehensive logging enables both immediate validation and long-term analysis of system performance and strategy effectiveness. The interaction database maintains historical records that inform future decisions and enable continuous system improvement. This architecture enables transparent, human-like decision-making across various contexts, from simple social interactions to complex professional scenarios. The system maintains clear accountability while implementing effective strategic communication, with each component contributing to a balanced, ethical approach to information management.

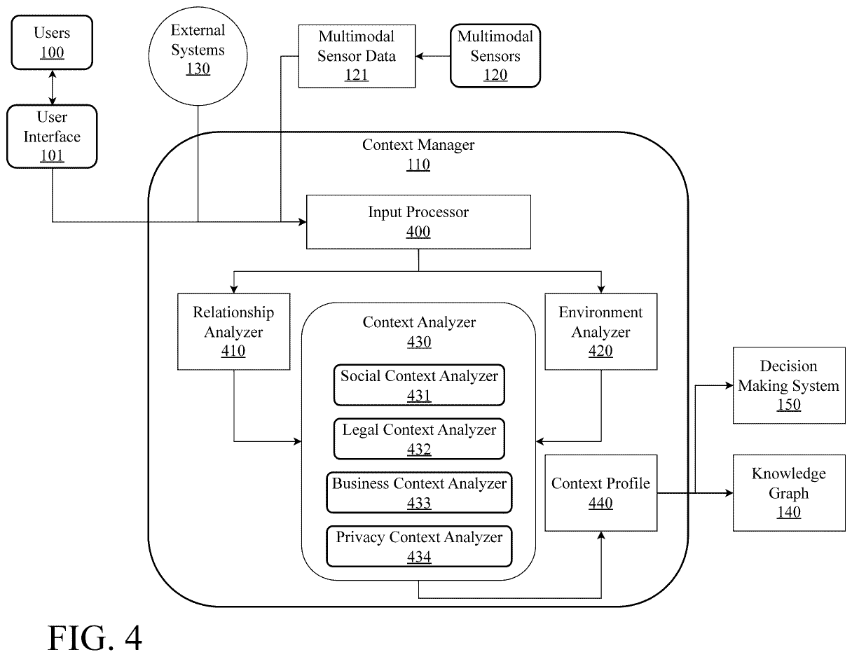

FIG. 4 is a block diagram illustrating an exemplary subsystem for AI agents with bluffing capabilities in an agent decision system, a context manager. Context manager 110 receives input from multiple sources. Users 100 interact through the user interface 101, while multimodal sensors 120 provide multimodal sensor data 121 capturing subtle social and environmental cues. External systems 130 contribute additional domain-specific information. These diverse inputs flow into an input processor 400 that standardizes and prepares the data for analysis.

The processed input feeds into two specialized analyzers—a relationship analyzer 410 and environment analyzer 420. Relationship analyzer 410 evaluates interpersonal dynamics, trust levels, and social networks, while environment analyzer 420 assesses situational factors, physical context, and environmental conditions that might influence interaction strategies.

A context analyzer 430 integrates these analyses through a plurality of specialized components. A social context analyzer 431 evaluates social dynamics, relationships, and cultural factors. A legal context analyzer 432 assesses compliance requirements and regulatory considerations. A business context analyzer 433 evaluates professional and commercial factors, while a privacy context analyzer 434 ensures appropriate information handling based on sensitivity and disclosure requirements.

These analyses culminate in a comprehensive context profile 440 that interfaces with the knowledge graph 140. Knowledge graph 140 maintains semantic relationships between various contextual elements, enabling reasoning about interaction contexts. This contextual understanding feeds into decision making system 150, enabling informed strategy selection and execution. The context manager's architecture enables nuanced understanding of complex interaction scenarios, considering multiple dimensions of context simultaneously. Each analyzer contributes specific insights that help the system navigate social, professional, and regulatory requirements while maintaining appropriate boundaries and strategic effectiveness.

Still another expansion comprises an extensible plugin architecture allowing third-party or proprietary domain modules to be seamlessly integrated into the AI agent platform. These plugins could encapsulate specialized knowledge bases (e.g., tax codes, maritime law, advanced engineering standards) or domain-tailored heuristic packages for highly specialized negotiations—such as multi-party environmental treaties or cross-border IP licensing deals. Each plugin registers its schema, dependency profiles, and rule hierarchies with the context manager, thereby permitting dynamic loading or unloading when relevant triggers appear—such as a new legislative environment, an updated risk model, or user-submitted custom clauses.

To implement this architecture, the system includes a standardized plugin interface defining message formats, security protocols (e.g., credential checks, encryption standards), and machine-readable rule declarations. Before going live, each plugin undergoes a sandboxed validation phase to confirm compatibility with existing role-based rules, the system's ethics enforcer, and the content filter. Upon approval, the plugin becomes accessible to the multi-agent environment, where specialized agents can invoke or consult the plugin's capabilities. For example, a Financial Derivatives Plugin might parse complex term sheets for advanced hedge instruments, while a Medical Insurance Plugin could supply context-specific parameters for coverage negotiations involving multiple insurers. This modular plugin strategy allows the invention to quickly scale to new domains, ensuring that the core platform remains stable while still encouraging extensibility for emerging requirements.

Knowledge graph 140 structures role-based rules and relationships using a hierarchical graph database architecture where nodes represent entities (roles, regulations, organizations) and edges represent relationships and constraints between them. For example, a medical professional node connects to HIPAA regulation nodes, patient confidentiality requirements, and specific disclosure restrictions, each with weighted importance scores. The graph implements a semantic triple structure (subject-predicate-object) to encode complex rules—for instance, “Doctor-MustProtect-PatientInfo” links to specific conditions defining protected health information and allowable disclosure scenarios. When ethics enforcer 151 needs to validate a proposed action, it traverses the graph using a multi-step query process. In one embodiment it may first identify all applicable role nodes from the context profile, then gather connected regulation and requirement nodes, and finally aggregate constraint rules using a weighted scoring algorithm. The scoring algorithm assigns higher weights to strict regulatory requirements (like HIPAA violations) compared to social norms (like professional courtesy). For business interactions, the graph maintains industry-specific compliance rules connected to role nodes, with edges encoding both mandatory requirements (e.g., SEC disclosure rules) and situational guidelines (e.g., negotiation best practices). Rules engine 810 uses graph pattern matching to identify applicable constraints, while content filter 800 references linked content classification nodes to determine appropriate communication boundaries. This structured approach enables the ethics enforcer to efficiently evaluate proposed actions against a comprehensive framework of professional, legal, and social requirements, with each query returning a quantified assessment of ethical compliance.

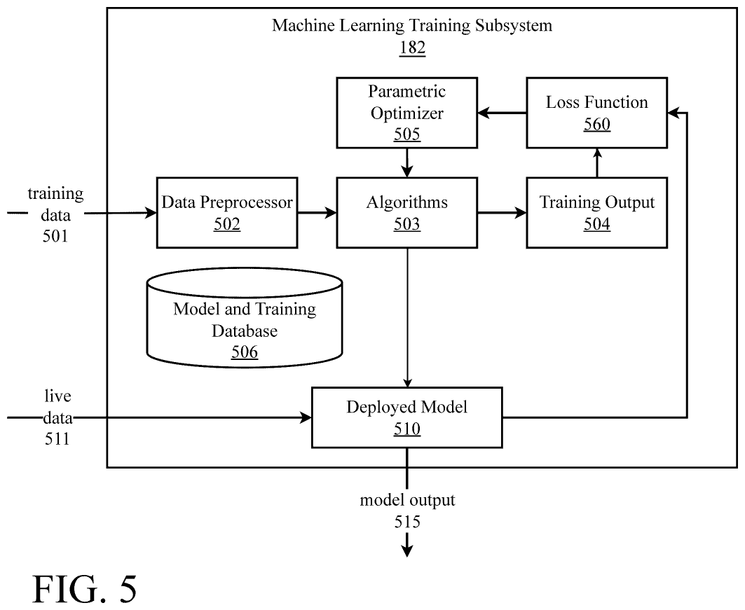

FIG. 5 is a block diagram illustrating an exemplary subsystem for AI agents with bluffing capabilities in an agent decision system, machine learning training system. According to the embodiment, the machine learning training subsystem 182 may comprise a model training stage comprising a data preprocessor 502, one or more machine and/or deep learning algorithms 503, training output 504, and a parametric optimizer 505, and a model deployment stage comprising a deployed and fully trained model 510 configured to perform tasks described herein such as processing codewords through a large codeword model. The machine learning training subsystem 182 may be used to train and deploy a plurality machine learning based analyzers within a bluffing AI platform.

At the model training stage, a plurality of training data 501 may be received by the machine learning training subsystem 182. Data preprocessor 502 may receive the input data (e.g., user inputs, contextual information, multimodal sensor data, user feedback, historical responses) and perform various data preprocessing tasks on the input data to format the data for further processing. For example, data preprocessing can include, but is not limited to, tasks related to data cleansing, data deduplication, data normalization, data transformation, handling missing values, feature extraction and selection, mismatch handling, and/or the like. Data preprocessor 502 may also be configured to create training dataset, a validation dataset, and a test set from the plurality of input data 501. For example, a training dataset may comprise 80% of the preprocessed input data, the validation set 10%, and the test dataset may comprise the remaining 10% of the data. The preprocessed training dataset may be fed as input into one or more machine and/or deep learning algorithms 503 to train a predictive model for object monitoring and detection.

During model training, training output 504 is produced and used to measure the accuracy and usefulness of the predictive outputs. During this process a parametric optimizer 505 may be used to perform algorithmic tuning between model training iterations. Model parameters and hyperparameters can include, but are not limited to, bias, train-test split ratio, learning rate in optimization algorithms (e.g., gradient descent), choice of optimization algorithm (e.g., gradient descent, stochastic gradient descent, of Adam optimizer, etc.), choice of activation function in a neural network layer (e.g., Sigmoid, ReLu, Tanh, etc.), the choice of cost or loss function the model will use, number of hidden layers in a neural network, number of activation unites in each layer, the drop-out rate in a neural network, number of iterations (epochs) in a training the model, number of clusters in a clustering task, kernel or filter size in convolutional layers, pooling size, batch size, the coefficients (or weights) of linear or logistic regression models, cluster centroids, and/or the like. Parameters and hyperparameters may be tuned and then applied to the next round of model training. In this way, the training stage provides a machine learning training loop.

In some implementations, various accuracy metrics may be used by the machine learning training subsystem 182 to evaluate a model's performance. Metrics can include, but are not limited to, word error rate (WER), word information loss, speaker identification accuracy (e.g., single stream with multiple speakers), inverse text normalization and normalization error rate, punctuation accuracy, timestamp accuracy, latency, resource consumption, custom vocabulary, sentence-level sentiment analysis, multiple languages supported, cost-to-performance tradeoff, and personal identifying information/payment card industry redaction, to name a few. In one embodiment, the system may utilize a loss function 560 to measure the system's performance. The loss function 560 compares the training outputs with an expected output and determined how the algorithm needs to be changed in order to improve the quality of the model output. During the training stage, all outputs may be passed through the loss function 560 on a continuous loop until the algorithms 503 are in a position where they can effectively be incorporated into a deployed model 515.

The test dataset can be used to test the accuracy of the model outputs. If the training model is establishing correlations that satisfy a certain criterion such as but not limited to quality of the correlations and amount of restored lost data, then it can be moved to the model deployment stage as a fully trained and deployed model 510 in a production environment making predictions based on live input data 511 (e.g., user inputs, contextual information, multimodal sensor data, user feedback, historical responses). Further, model correlations and restorations made by deployed model can be used as feedback and applied to model training in the training stage, wherein the model is continuously learning over time using both training data and live data and predictions. A model and training database 506 is present and configured to store training/test datasets and developed models. Database 506 may also store previous versions of models.

According to some embodiments, the one or more machine and/or deep learning models may comprise any suitable algorithm known to those with skill in the art including, but not limited to: LLMs, generative transformers, transformers, supervised learning algorithms such as: regression (e.g., linear, polynomial, logistic, etc.), decision tree, random forest, k-nearest neighbor, support vector machines, Naïve-Bayes algorithm; unsupervised learning algorithms such as clustering algorithms, hidden Markov models, singular value decomposition, and/or the like. Alternatively, or additionally, algorithms 503 may comprise a deep learning algorithm such as neural networks (e.g., recurrent, convolutional, long short-term memory networks, etc.).

In some implementations, the machine learning training subsystem 182 automatically generates standardized model scorecards for each model produced to provide rapid insights into the model and training data, maintain model provenance, and track performance over time. These model scorecards provide insights into model framework(s) used, training data, training data specifications such as chip size, stride, data splits, baseline hyperparameters, and other factors. Model scorecards may be stored in database(s) 506.

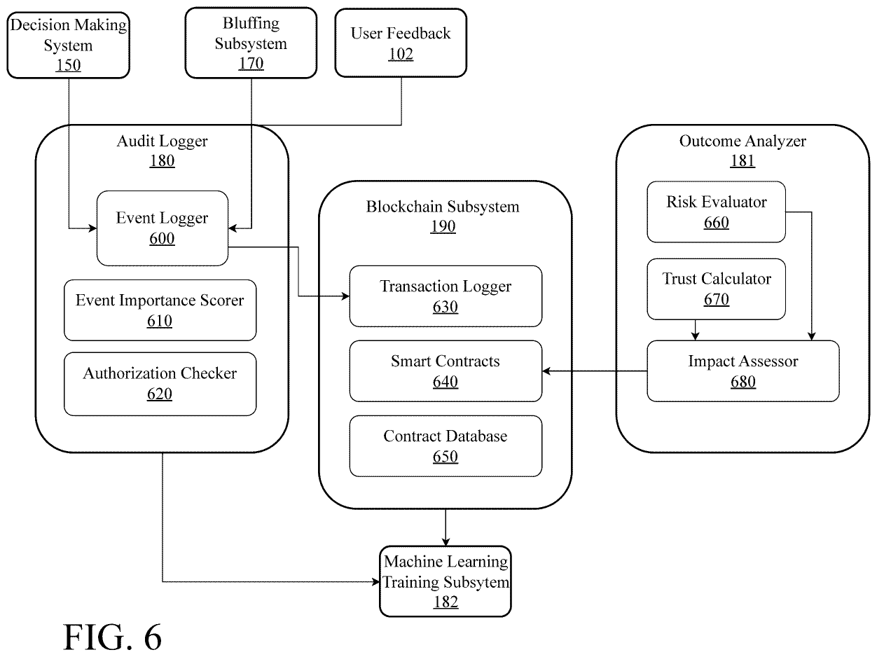

FIG. 6 is a block diagram illustrating exemplary subsystems for AI agents with bluffing capabilities in an agent decision system, an audit logger, a blockchain subsystem, and an outcome analyzer. The audit system receives inputs from decision making system 150 and bluffing subsystem 170, which feed into audit logger 180. Audit logger's event logger 600 creates detailed records of all system actions and decisions. These events are processed by an event importance scorer 610 that assigns priority levels based on the significance and potential impact of each action. An authorization checker 620 verifies that all actions were executed within appropriate permission boundaries and role-based constraints.

In one embodiment, a blockchain subsystem 190 provides immutable record-keeping through a transaction logger 630. Smart contracts 640 implement automated validation and execution rules, with all contract parameters and conditions stored in a contract database 650. This blockchain implementation ensures that decisions and actions have tamper-proof documentation, particularly valuable in professional contexts requiring strict accountability.

Outcome analyzer 181 processes system actions through multiple evaluation components. A risk evaluator 660 assesses the risks associated with different strategies and their outcomes, while a trust calculator 670 monitors how different actions impact trust levels in various relationships. An impact assessor 680 evaluates the broader consequences of system actions across different contextual dimensions.

User feedback 102 provides input for system improvement, feeding into the machine learning training subsystem 182. This training subsystem integrates feedback with audit data and outcome analyses to refine system strategies and decision-making processes. The comprehensive nature of this feedback loop enables continuous improvement while maintaining strict accountability through the audit infrastructure.

This architecture enables the tracking and analysis of system performance while ensuring all actions remain traceable and accountable. The integration of blockchain technology provides an additional layer of trust and verification, particularly valuable in regulated professional contexts or high-stakes interactions where documentation of decision processes is important.

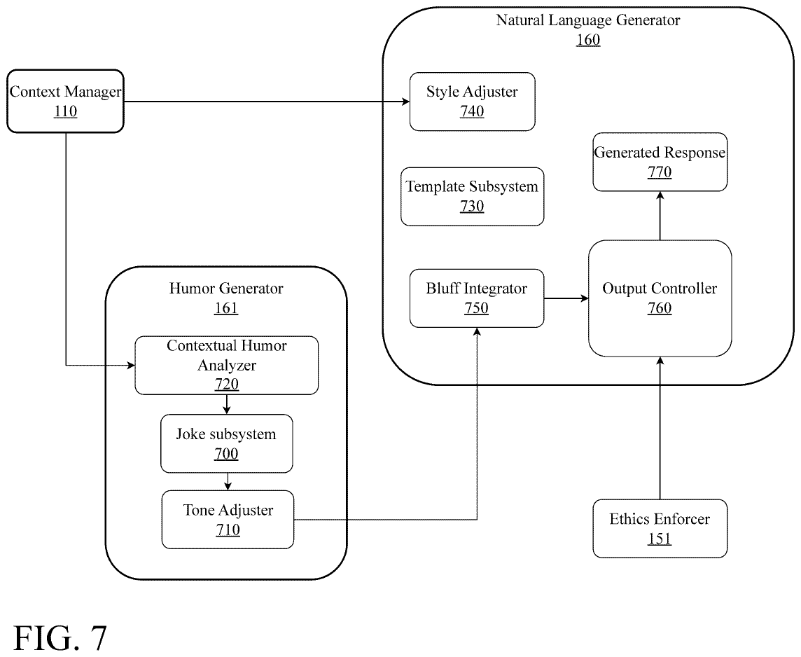

FIG. 7 is a block diagram illustrating an exemplary subsystem for AI agents with bluffing capabilities in an agent decision system, a humor generator and a natural language generator. The system receives input from the context manager 110, which provides situational awareness to both the humor generator 161 and natural language generator 160 components. The humor generator includes a joke subsystem 700 that generates contextually appropriate humorous elements. A tone adjuster 710 modulates the humor intensity and style, while a contextual humor analyzer 720 ensures all humorous elements are appropriate for the current situation and audience.

The natural language generator's template subsystem 730 provides base structures for different types of communications, which are refined by a style adjuster 740 to match the required tone and formality level. A sophisticated bluff integrator 750 incorporates strategic elements determined by earlier system components, weaving them naturally into the generated response.

An output controller 760 manages the final composition of responses, coordinating with ethics enforcer 151 to ensure all communications remain within appropriate boundaries. Ethics enforcer 151 validates that generated responses maintain professional standards and role-appropriate behavior while achieving strategic objectives. This process culminates in a generated response 770, which balances effective communication with appropriate social grace and strategic goals.

This architecture enables the system to generate responses that maintain natural conversational flow while implementing strategic communication objectives. The integration of contextual humor adds an important dimension of social intelligence, helping to maintain rapport and engagement even in situations requiring careful information management. The constant oversight of the ethics enforcer ensures all communications, including humorous elements, remain appropriate for the professional or social context at hand.

In further embodiments, the Machine Learning Training Subsystem is augmented with a Dynamic Agent Training and Simulation Framework that facilitates real-time or near-real-time reinforcement learning. This framework can launch simulated negotiation environments wherein multiple instances of specialized agents compete or collaborate under varying conditions, akin to a continuous “self-play” format. Drawing on research from advanced poker AIs and complex strategic board games, the system uses adversarial matchups to refine bluffing heuristics, risk tolerances, and strategic omission parameters. The framework tracks performance metrics—such as settlement speed, user satisfaction, resource efficiency, or compliance infractions—to shape each agent's policy updates. The Machine Learning Training Subsystem further supports continuous learning mechanisms based on Reinforcement Learning with Self-Play, including multi-Agent Self-Play where agents train by competing with variants and prior versions of themselves, and by running new or existing cases with different reward functions to adapt and hone strategies. For example, in a scenario where company A is negotiating an asset purchase of company B. In one version of this negotiation company A may prioritize getting the lowest purchase price, while in another it may be ensuring high risk assets are not included. While the global outcome of this purchase being successful is the same in both cases, the cost function is different and requires an adaptation of negotiation strategies. Agents may also continue to learn by integrating with federated cross-agent knowledge sharing. This is where domain expert agents may teach via methods such as discussion, synthesizing scenarios and evaluating/scoring methods, or provide enough information that the target agent can learn by comprehension. These domain expert agents may alternatively be humans. Agents may also integrate new, novel, landmark, or other existing negotiations conducted by humans, where sufficient documentation exists. These agent simulation environments support many learning methods—such as Meta-Learning (learning to learn), Neural Architecture Search for Self Optimization, by expanding knowledge graph integration via Continuous Knowledge Graph Expansion, Context-Aware learning via transfer learning, or ontology-based learning for structured knowledge representations.

This simulation environment may integrate a user or “human in the loop” step, whereby domain experts occasionally interject new rules or provide ground-truth labels for ethically grey or ambiguous scenarios. The system stores these interjections in the Audit Logger, effectively creating a historical corpus of user interventions that refine subsequent training sessions. Through iterative runs, agents develop more robust negotiation tactics that balance deceptive signals (bluffs, omissions) with essential ethical or regulatory constraints. This dynamic approach ensures that the system improves over time, even in rapidly evolving industries or contexts where rules and best practices frequently change.

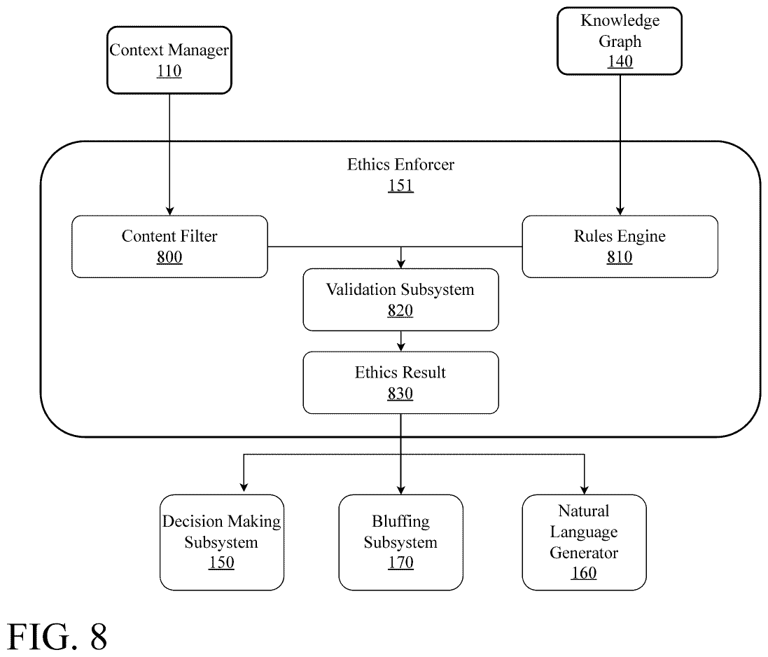

FIG. 8 is a block diagram illustrating an exemplary subsystem for AI agents with bluffing capabilities in an agent decision system, an ethics enforcer. Ethics enforcer 151 operates as a central governance component, receiving contextual information from context manager 110 and accessing role-based rules and relationships through knowledge graph 140. A content filter 800 screens all proposed communications and actions against multiple dimensions of appropriateness, including age-appropriate content, professional standards, and social norms.

A rules engine 810 implements core ethical principles and professional guidelines, drawing upon the knowledge graph to understand context-specific requirements and constraints. This engine maintains rule sets for different professional roles, regulatory requirements, and social contexts, ensuring all system actions align with appropriate standards.

A validation subsystem 820 performs real-time verification of proposed actions and communications, generating an ethics result 830 that determines whether specific actions can proceed. This validation process interfaces decision making subsystem 150 for strategic choices, bluffing subsystem 170 for information management strategies, and natural language generator 160 for communication implementation.

This integrated approach ensures ethical compliance at multiple levels of system operation, from high-level strategy selection to specific communication choices. The architecture enables sophisticated yet responsible information management while maintaining strict adherence to professional standards and ethical guidelines. By implementing ethics enforcement as a central system component rather than an afterthought, the system maintains integrity in all interactions while achieving strategic objectives.

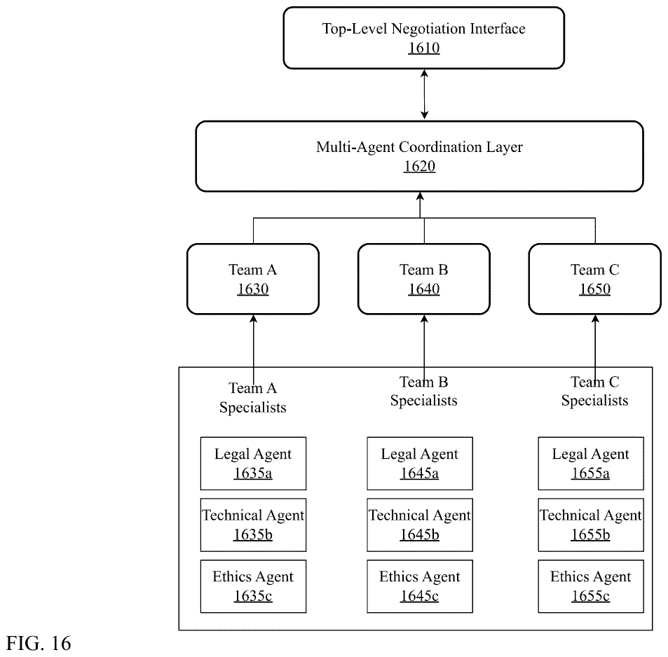

FIG. 16 is a block diagram illustrating the agent team architecture representing a sophisticated multi-layered system for AI-powered negotiations and decision-making process. While the architecture illustrates examples like legal, technical, and ethics, these represent just a small sample of the possible specialist roles that can be deployed within the system. The architecture is fundamentally designed as an extensible framework that may accommodate any type of specialized agent needed for a particular context or domain. This architecture enables AI agents to engage in complex negotiations while maintaining ethical boundaries and professional standards. The architecture implements a structure where the specialized AI agents work together in coordinated teams to achieve negotiation objectives while ensuring compliance and optimal outcomes. For instance, in a high-stakes business merger negotiation, multiple teams of AI agents might work simultaneously to evaluate financial terms, assess regulatory compliance, and manage stakeholder communications.

The negotiation interface 1610 serves as the primary coordination point for all stakeholder interactions. This interface manages the overall flow of negotiations and ensures proper protocol adherence. For example, during complex contract negotiations between a technology company and its suppliers, this layer might coordinate multiple parallel discussions about pricing, delivery terms, and technical specifications while maintaining appropriate information barriers between different aspects of the negotiation. The interface also implements sophisticated access controls and communication protocols to prevent unauthorized information disclosure or breaches of confidentiality. The multi-agent coordination layer 1620 orchestrates the activities of various specialized. This layer implements advanced mechanisms for managing both intra-team and inter-team interactions. Consider a scenario where a pharmaceutical company is negotiating licensing agreements with multiple research institutions. The coordination layer would manage how different specialist agents interact—legal agents 1635a, 1645a, 1655a, reviewing intellectual property terms, technical agents 1635b, 1645b, 1655b evaluating research methodologies, and ethics agents 1635c, 1645c, 1655c ensuring compliance with medical research standards. This layer ensures that all these specialized discussions remain aligned with overall negotiation objectives while maintaining appropriate professional boundaries.

In contrast to current techniques that focuses on training a single model for a narrow purpose (e.g., POKERBENCH's curated scenarios in the poker-playing domain), the present invention employs an agent coordination layer to manage a plurality of specialized agents—each embodying distinct domain expertise, negotiation strategies, or compliance mandates. Within this framework, a suite of autonomous or semi-autonomous agents—such as legal counsel agents, financial modeling agents, ethical oversight agents, and stakeholder engagement agents—communicate through a standardized messaging protocol, supporting direct, group, and broadcast communication modes. This multi-agent architecture not only supports concurrent negotiations and real-world multi-party deals but also enables cross-validation of strategic proposals among agents with distinct priorities (e.g., a compliance-focused agent may raise a red flag when a financial agent proposes an aggressive bluff). By expanding beyond a single-domain, single-agent environment, the invention addresses a broader scope of real-world challenges where multiple roles, regulations, and ethical considerations converge. In certain embodiments, multiple specialized agents—such as Financial Agents, Legal Agents, Ethics Agents, and Social Rapport Agents—jointly deliberate and validate bluffing decisions. This multi-agent synergy surpasses single-model poker-like benchmarks by enabling parallel, domain-specific scrutiny of each proposed bluffing maneuver. For instance, while a Financial Agent optimizes potential profit through an aggressive misdirection, an Ethics Agent references deontic logic rules to block or modify that approach if it breaches professional obligations, legal statutes, or confidentiality constraints. All agent outputs feed into a team-based debate mechanism, where each agent presents supporting data, symbolic rule validations, or sensor-derived metrics. A designated arbiter (or the global ethics enforcer) then finalizes the communication strategy, ensuring thorough cross-validation and robust negotiation outcomes. By managing real-time interplay among multiple domain experts and compliance modules, the system transcends typical single-agent strategic modeling and supports context-sensitive, ethically bounded bluffing at scale.

Each team 1630, 1640, 1650 operates as a cohesive unit with its own set of specialized agents, each bringing unique capabilities to the negotiation process. Legal agents handle all aspects of regulatory compliance and contract formation, analyzing terms for potential risks and ensuring all agreements meet applicable legal standards. In a cross-border merger negotiation, these agents might simultaneously evaluate compliance with multiple jurisdictions'requirements while coordinating with technical agents to ensure practical implementation feasibility. Technical agents focus on assessing and validating all technical aspects of negotiations, from evaluating proposed solutions to determining implementation requirements. In a complex IT service contract negotiation, these agents might analyze system integration requirements, evaluate service level agreements, and assess technical risk factors. The architecture implements sophisticated mechanisms for internal debate and decision-making within teams. When faced with a complex decision, agents engage in structured deliberation processes, presenting evidence and arguments to reach optimal conclusions. For example, in negotiating terms for a new medical device contract, the ethics agent might raise concerns about patient data privacy, while the technical agent presents solutions for secure data handling, and the legal agent ensures compliance with healthcare regulations. Through this deliberative process, the team arrives at solutions that balance multiple competing priorities while maintaining ethical standards.

Cross-team coordination occurs through both vertical and horizontal communication channels, enabling sophisticated collaboration patterns. In a multi-party negotiation scenario, such as a large-scale construction project, technical agents from different teams might directly coordinate on compatibility standards while legal agents ensure contract terms align across multiple agreements. This coordinated approach allows for efficient problem-solving while maintaining appropriate boundaries between different aspects of the negotiation. The system incorporates advanced learning and adaptation mechanisms, continuously improving its negotiation capabilities through experience. Each interaction generates valuable data about successful strategies, potential pitfalls, and optimal approaches for different scenarios. For instance, when negotiating technology licensing agreements, the system might learn that early disclosure of certain technical capabilities leads to more favorable terms, while in real estate negotiations, it might learn that staged information release creates better outcomes.

Decision validation in the architecture involves multiple layers of verification and compliance checking. Every significant decision may pass through rigorous validation processes that ensure alignment with ethical guidelines, professional standards, and stakeholder interests. For example, in healthcare industry negotiations, decisions are validated against patient privacy requirements, medical ethics guidelines, and regulatory compliance standards. This multi-layered validation approach ensures that all actions maintain appropriate professional boundaries while achieving strategic objectives. The architecture's sophisticated capabilities enable it to handle negotiations ranging from straightforward business transactions to complex multi-party agreements while maintaining strict ethical standards and professional boundaries. By combining specialized expertise with coordinated decision-making and continuous learning, the system effectively represents stakeholder interests across various scenarios while ensuring all interactions remain within appropriate professional and ethical boundaries.

The agent team architecture introduces a revolutionary approach to agent organization where specialized AI agents collaborate in flexible teams, each bringing unique capabilities to negotiations and decision-making processes. The architecture diagram illustrates examples like legal, technical, and ethics, these represent just a small sample of the possible specialist roles that can be deployed within the system. The architecture is fundamentally designed as an extensible framework that may accommodate any type of specialized agent needed for a particular context or domain. In legal proceedings for instance, the system might deploy a sophisticated network of specialized agents working in concert. A plaintiff team could include agents specializing in evidence analysis, precedent research, damages calculation, and witness statement correlation. The defendant team might employ agents focused on counter-argument construction, liability assessment, settlement optimization, and regulatory compliance verification. Overseeing these interactions, judicial agents may specialize in procedural compliance, bias detection, legal framework application, and fairness maintenance. Additional specialist agents might focus on specific aspects like e-discovery optimization, document authentication, jurisdictional analysis, and legal writing standardization. For example, in a complex intellectual property dispute, a plaintiff team may combine patent analysis agents, market impact assessment specialists, and technical infringement evaluators. The defendant team could deploy prior art research agents, innovative timeline specialists, and patent validity analysts. Judicial agents would then coordinate procedural agents for motion handling, evidence admissibility specialists, and legal precedent correlation experts. The system might also create specialized task forces combining agents from different teams to address specific issues, such as when technical patent agents from both sides work with neutral technical standard agents under judicial oversight to evaluate specific claims.

In financial negotiations, teams might include specialized agents focused on risk assessment, market analysis, quantitative modeling, and currency hedging. A pharmaceutical research collaboration might employ agents specializing in clinical trial design, biostatistics, patient safety monitoring, and drug interaction analysis. In construction project negotiations, specialist agents might focus on architectural compliance, materials science, environmental impact assessment, and construction scheduling optimization.

Through this flexible and extensible approach, the AI agent team architecture transcends the limitations of fixed specialist roles, enabling organizations to deploy precisely the combination of expert agents needed for any given negotiation scenario. This adaptability, combined with the architecture's sophisticated coordination and learning mechanisms, creates a powerful platform for handling complex negotiations across any domain or industry context.

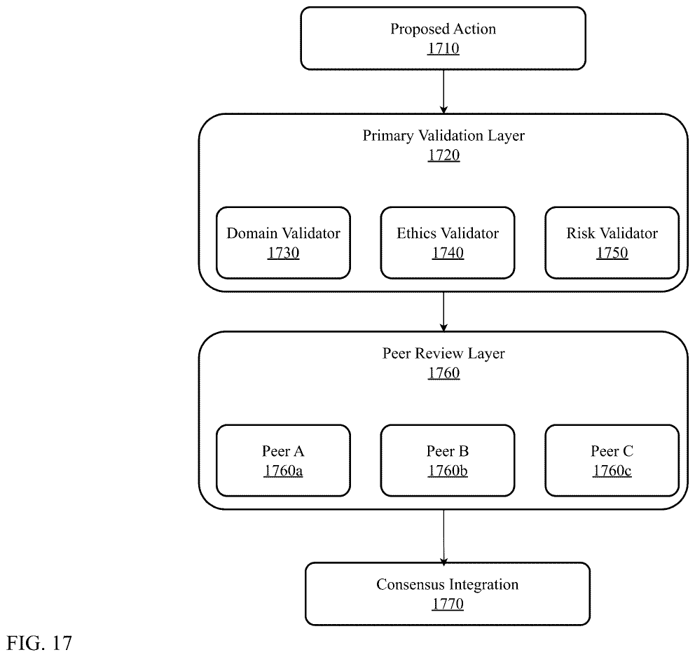

FIG. 17 is a block diagram illustrating an exemplary architecture for the cross-agent validation architecture representing a sophisticated system for ensuring the accuracy and reliability of AI decisions through multiple layers of verification and validation. This architecture demonstrates how multiple AI agents can work together to identify and correct potential errors while maintaining high standards of accuracy and ethical compliance.

The proposed action 1710 enters the system for validation. This could be anything from a strategic negotiation position to a complex technical recommendation. For example, consider a complex pharmaceutical licensing negotiation: the initial proposal might include terms for intellectual property rights, manufacturing requirements, and revenue sharing arrangements. This proposal would flow through three distinct but interconnected validation layers, each providing crucial oversight from different perspectives. The proposal immediately enters the primary validation layer 1720 where it may be the first line of defense against potential errors or issues. This layer implements three parallel validation streams: domain validators 1730, ethics validators 1740, and risk validators 1750. Each validator brings specialized expertise to the assessment process. The domain validator 1730 examines the technical accuracy and feasibility of the proposed action. This validator ensures that all domain-specific requirements are met and that the proposal aligns with established best practices in the field. For example, in a financial transaction, the domain validator 1730 might assess compliance with accounting standards and market regulations. In our pharmaceutical example, this validator might analyze patent claims, evaluate manufacturing scalability requirements, and verify compliance with industry standards. The domain validation process incorporates sophisticated knowledge models that can adapt to different contexts—for instance, switching between pharmaceutical regulation frameworks for different global markets. Running in parallel, the ethics validator 1740 examines the proposal for alignment with ethical principles and professional standards. This implements sophisticated frameworks for ethical assessment, ensuring that all actions maintain appropriate boundaries and respect established guidelines. The ethics validator 1740 can identify subtle ethical concerns that might not be immediately apparent, such as potential conflicts of interest or unintended consequences. This validator might assess patient access implications, research data transparency requirements, and potential conflicts of interest. The ethics validation process is particularly crucial as it helps prevent what researchers have identified as “sycophancy bias”—where AI systems might agree with unethical proposals just to please users. The risk validator 1750 employs advanced modeling techniques to identify potential vulnerabilities and downstream consequences. In our pharmaceutical example, this might include analyzing supply chain risks, evaluating market competition scenarios, and assessing regulatory compliance risks across different jurisdictions. The risk validation process incorporates both immediate and long-term risk assessment, using sophisticated predictive models to identify potential future challenges. This validator employs advanced risk modeling techniques to identify both immediate and long-term risks that might arise from the decision. The risk validator's assessment includes consideration of various scenarios and potential outcomes, helping to ensure comprehensive risk evaluation.

The architecture then moves to the peer review layer 1760, where multiple peer agents 1760a-c engage in collaborative verification of the primary validators'assessments. This layer implements recent research findings about the effectiveness of AI debate in surfacing truth and identifying errors. Peer agents can challenge each other's assumptions and conclusions, leading to more robust validation outcomes. For instance, if the domain validator approves certain manufacturing requirements, peer agents might debate whether these requirements could inadvertently create quality control issues under specific conditions. Within the peer review layer 1760, agents engage in structured cross-validation processes. Each peer agent can review the work of others and provide additional perspectives or identify potential oversights. The peer review process includes sophisticated mechanisms to prevent common issues identified in research, such as sycophancy bias or undue influence from superficial factors. Peer agents communicate through both direct channels and collaborative discussion forums, enabling thorough examination of all aspects of the validation process. The peer review process implements sophisticated protocols to prevent common pitfalls identified in recent research. For example, the system includes mechanisms to ensure that validation isn't unduly influenced by factors like argument length or presentation style. Instead, it focuses on the substance of the validation arguments and their supporting evidence. When peer agents disagree about a validation decision, they engage in structured debate to resolve the disagreement, similar to how researchers found that allowing AI systems to argue different positions led to better outcomes.

The final stage involves the consensus integration 1770, where all validation inputs are synthesized into a final validation decision. This integration process uses advanced algorithms to weight different perspectives based on their relevance and reliability. The consensus mechanism may carefully consider dissenting views and ensures that all significant concerns are properly addressed before reaching a final validation decision. The consensus integration implements advanced algorithms that can weight different validation inputs based on their relevance and reliability. For example, in our pharmaceutical licensing scenario, the consensus mechanism might give greater weight to patient safety considerations over pure financial optimization. Throughout the entire process, the system maintains comprehensive audit trails and documentation of all validation steps and decisions. This creates a transparent record of how validation decisions were reached, enabling future review and continuous improvement of the validation process. The system also implements continuous learning mechanisms, using the outcomes of validation decisions to refine and improve its validation criteria and processes over time. The architecture may include sophisticated feedback loops that enable it to adapt and improve based on experience. When a validation decision prove particularly effective or when potential improvements are identified, this information feeds back into the system to enhance future validation processes. This continuous improvement cycle helps the system become increasingly effective at identifying and preventing potential errors or issues in proposed actions. This multi-layered, collaborative approach to validation helps ensure that AI decisions remain reliable and trustworthy, even as they become increasingly sophisticated. By implementing multiple layers of validation and verification, while maintaining clear documentation and accountability, the system provides robust protection against potential errors or oversights in AI decision-making.

### Detailed Description of Exemplary Aspects

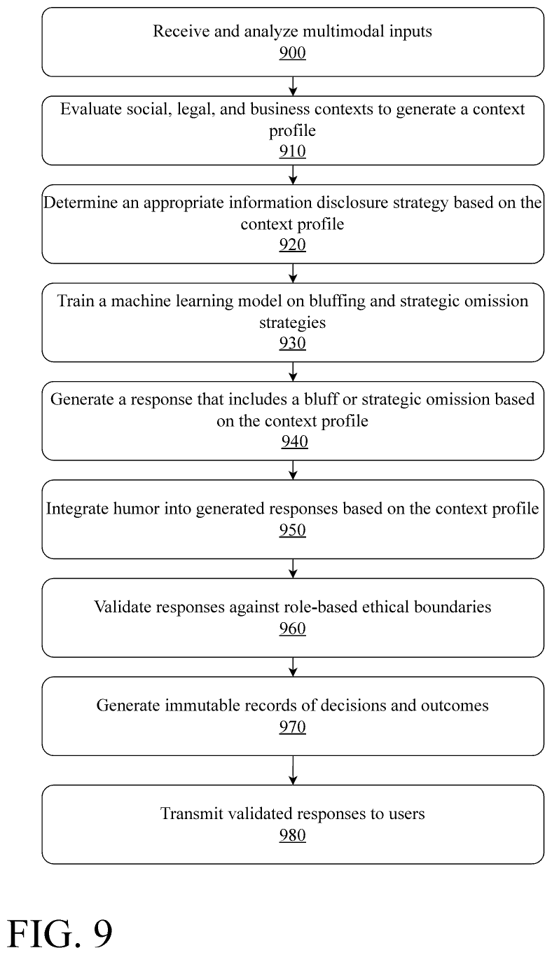

FIG. 9 is a flow diagram illustrating an exemplary method for an AI agents with bluffing capabilities in an agent decision platform. In a first step 900, the system receives and analyzes multimodal inputs including facial expressions, tone of voice, and environmental data from sensors. These inputs might include, for example, detecting micro-expressions indicating discomfort during negotiations or changes in voice tone suggesting skepticism.

In a step 910, the system evaluates multiple context dimensions to generate a comprehensive profile. This includes but is not limited to analyzing social relationships and hierarchies, checking legal requirements such as HIPAA compliance for medical contexts or fiduciary duties for business settings, and assessing business factors like negotiation positions or market conditions. In a step 920, the system determines appropriate information disclosure strategies based on the context profile. Using principles derived from poker AI research and game theory, the system calculates optimal approaches for managing information, whether in social situations like declining invitations or business contexts like price negotiations.

In a step 930, the system trains machine learning models specifically for bluffing and strategic omission. This training incorporates reinforcement learning from past interactions, learning patterns of successful information management across different contexts, such as how to effectively navigate sensitive negotiations or manage social grace in declining invitations.

In a step 940, the system generates responses incorporating strategic omissions or bluffs based on the context profile. For example, in a negotiation context, the system might strategically omit specific budget constraints while emphasizing other factors, or in a social context, might craft a polite decline without revealing the true reason for unavailability.

In a step 950, the system integrates contextually appropriate humor into the generated responses. This might include light jokes to ease tension in negotiations or witty remarks to maintain social grace while declining invitations, always ensuring the humor aligns with the professional context and relationship dynamics.

In a step 960, the system validates all responses against role-based ethical boundaries. For example, ensuring that a doctor's responses maintain patient confidentiality, or that a corporate executive's communications comply with securities regulations and fiduciary duties.

In a step 970, the system generates immutable records of all decisions and outcomes using blockchain technology. These records capture the context, strategy selection, and response generation process, enabling audit trails particularly valuable in professional or regulated contexts. In a step 980, the system transmits the validated responses to users, having ensured that all communications maintain appropriate ethical boundaries while achieving strategic objectives. The final response balances effectiveness with professional standards and social grace.

Unlike current state of the art benchmarks in expert bluffing such as POKERBENCH, which evaluate static poker scenarios in a single domain, the disclosed invention enables dynamic, real-time negotiations spanning multiple domains—including but not limited to business contracts, healthcare insurance discussions, legal settlements, and procurement agreements—allowing asymmetric agent knowledge, and dynamic negotiation requirements. A Context Manager continuously refines the negotiation state as external inputs, user feedback, and new facts emerge (e.g., counterparties changing their requests, updates in applicable legal precedents, changing requirements based on human input, or newly introduced regulatory constraints). Concurrently, the bluffing subsystem and specialized agents adapt their disclosure strategies or risk thresholds to match the evolving context. By embedding a stateful negotiation engine that responds to live inputs, and integrating with a dynamic knowledge graph, the system achieves a level of responsiveness and contextual breadth absent from benchmarks tailored to a single, static poker environment. To drive nuanced bluffing decisions, the Context Manager performs comprehensive, multimodal sensor fusion (including video, audio, physiological signals) and external data queries (e.g., updated regulation libraries, dynamic market feeds). This collected intelligence is translated into a unified context profile, enriched by specialized analyzers (e.g., social relationship graphs, business constraints, legal compliance). The Manager's symbolic inference engine, integrated with a deontic reasoning layer, continuously checks whether the current situation grants permission or imposes obligation to reveal, withhold, or restructure information. For instance, if privacy laws or user-defined confidentiality parameters are triggered, the system restricts disclosure of sensitive details. Conversely, if sensor data signals the counterpart's rising agitation, the Manager may encourage a more conciliatory, partial-disclosure strategy that ameliorates tension. This dynamic interplay ensures that the Bluffing Subsystem always receives the most up-to-date, regulation-aware, and ethically annotated context possible, minimizing risks of unethical deception. Because strategic misdirections can clash with industry regulations or user-established moral codes, deontic conflict resolution is incorporated to prioritize certain obligations (e.g., “always protect confidentiality”) over lesser permissions (e.g., “downplay budget constraints”). A conflict resolution engine embedded in the Bluffing Subsystem evaluates “obliged” vs. “prohibited” markers on candidate bluff actions, while referencing hierarchical rule weightings within the knowledge graph. In cases where multiple high-priority obligations conflict—such as restricting strategic deception for ethical reasons but also adhering to minimal disclosure mandates from a user—an optimization solver (like an SMT or constraint solver) is deployed to identify the “least violating” course of action. “least violating” calculations are necessary where one or more requirements need some degree of interpretation and are not as clearly defined (such as government policies or laws). In this case the agent will assess the likelihood and degree to which the proposed choice or strategy will violate a particular requirement, and weigh that with the anticipated penalty and expected negotiation outcome. While specific scenarios and configurations may permit optimizing for the “least violating” outcome, there may also be scenarios where critical requirements come into conflict. These would be rules that must be followed without exception. In this scenario the agent must evaluate earlier choices that led to this conflict and possibly take a different negotiation path, or pause for human input. All decisions, including the specific rules or prompts invoked, are logged in an immutable ledger (e.g., blockchain or tamper-proof store) for post-hoc audits. This mechanism preserves transparency, enabling authorized reviewers to reconstruct why a particular misdirection or partial disclosure was selected over others, thereby fulfilling accountability requirements that are absent in simpler or single-domain bluffing systems.

The agents are explicitly designed to analyze and optimize within legal bounds, not circumvent them. While they may identify negotiation opportunities with some flexibility in interpretation—particularly in areas like tax law or contract terms—the system's ethical constraints and validation layers ensure that proposed strategies remain fully compliant with applicable laws and regulations. Any potential “wiggle room” is explored only within the strict confines of legal and ethical boundaries, with a clear bias toward conservative interpretation when uncertainty exists. The optimization process specifically excludes illegal actions from the solution space, regardless of potential gains, maintaining rigid compliance with both the letter and spirit of relevant laws.

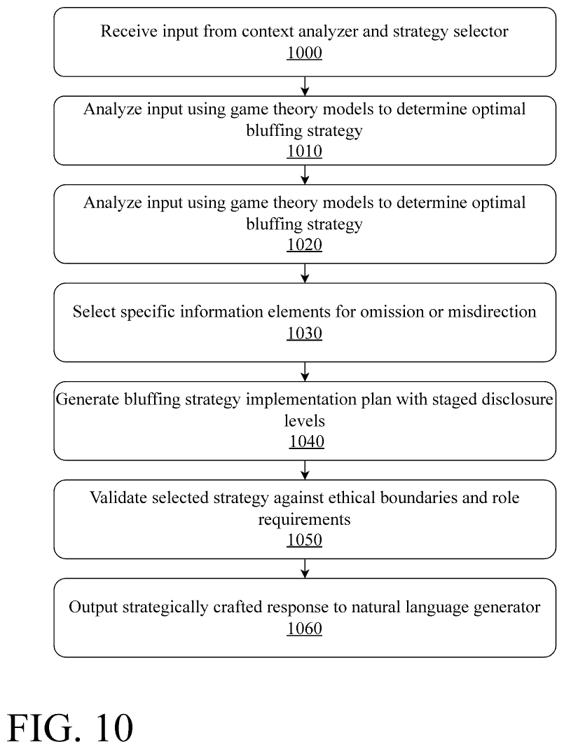

FIG. 10 is a flow diagram illustrating an exemplary method for generating bluffs and omissions with AI agents in an agent decision platform. In a first step 1000, the bluffing subsystem receives processed input from the context analyzer and strategy selector. This input includes comprehensive situational analysis, such as the nature of a negotiation, relationship dynamics between parties, and strategic objectives. For example, in a business negotiation, this might include counterparty history, current market conditions, and desired outcomes.

In a step 1010, the system analyzes the input using game theory models developed from poker AI research to determine optimal bluffing strategies. These models, including Bayesian belief manipulation and counterfactual reasoning, help calculate the most effective approach. For instance, in a pricing negotiation, the system might evaluate multiple possible disclosure paths and their likely outcomes.

In a step 1020, the system calculates risk levels and predicted outcomes for potential bluffing strategies. Using reinforcement learning from past interactions, it evaluates potential consequences of different approaches. This might include assessing how withholding certain information could affect trust levels or analyzing how different disclosure strategies might influence negotiation outcomes. Finally, certain embodiments employ multi-objective or hybrid reinforcement learning algorithms that evaluate agent performance not solely on immediate financial or strategic gain but also on compliance, social rapport, and user-defined ethical objectives. Each agent's reward signal encompasses (i) a Strategic Score (capturing negotiation outcomes, monetary benefits, or successful dispute resolutions), (ii) an Ethical Score (reflecting adherence to regulations, user trust retention, or stakeholder satisfaction), and optionally (iii) a Transparency Score (incentivizing appropriate disclosures at key negotiation junctures). As a result, models avoid over-optimizing on purely exploitative behaviors typical of poker AIs. This multi-faceted reward design ensures real-world viability in high-stakes corporate, medical, or legal negotiations—fully distinguishing the invention from single-dimensional benchmarks like POKERBENCH.

In a step 1030, the system selects specific information elements for omission or misdirection. Drawing on structural causal games, it identifies which pieces of information to withhold, partially reveal, or strategically present. For example, in a social context, this might involve choosing to omit specific reasons for declining an invitation while emphasizing schedule conflicts. In a step 1040, the system generates a detailed implementation plan with staged disclosure levels. This plan outlines how information will be revealed over time, similar to how poker players manage their hand information. The plan might include multiple stages of disclosure based on how the interaction progresses.

In a step 1050, the system validates the selected strategy against ethical boundaries and role requirements. For instance, ensuring that a doctor's strategic communications never violate patient confidentiality, or that a corporate executive's bluffing strategies remain within legal and fiduciary duty boundaries.

In a step 1060, the system outputs the strategically crafted response to the natural language generator. This output includes both the content to be communicated and specific parameters for tone, style, and potential humor integration to maintain social grace while achieving strategic objectives.

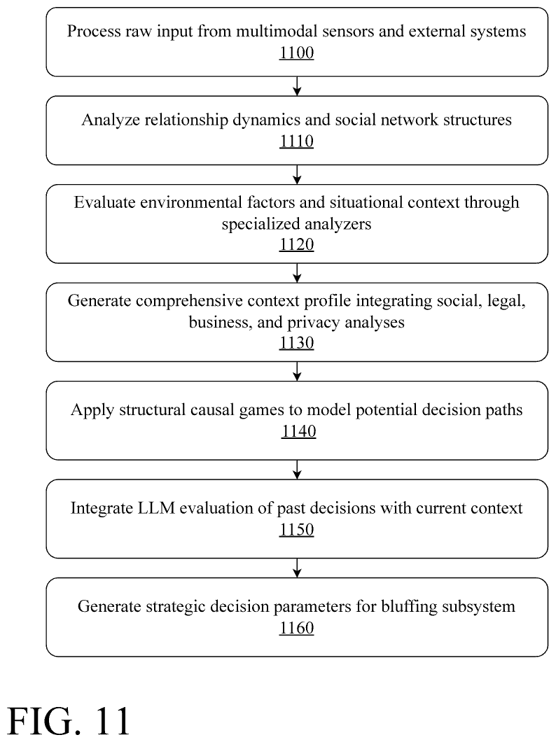

FIG. 11 is a flow diagram illustrating an exemplary method for developing context profiles for AI agents in an agent decision platform. In a first step 1100, the system processes raw input from multimodal sensors and external systems. This includes facial expression analysis capturing micro-expressions, voice tone analysis detecting subtle emotional cues, and data from external systems such as negotiation platforms, e-commerce systems, and legal/medical databases. For example, in a business negotiation, this might include both the counterparty's visible reactions and relevant market data.

In a step 1110, the system analyzes relationship dynamics and social network structures. This involves mapping professional hierarchies, trust levels, and relationship histories between parties. For instance, understanding the difference between interactions with close family members versus casual business acquaintances, or mapping complex professional relationships in regulated industries.

In a step 1120, the system evaluates environmental factors and situational context through specialized analyzers. These analyzers assess factors like location appropriateness, time sensitivity, and environmental constraints. For example, determining whether a conversation is happening in a public space versus a private office, or evaluating the formality level required for different professional contexts.

In a step 1130, the system generates a comprehensive context profile integrating social, legal, business, and privacy analyses. This profile combines all analyzed factors into a coherent understanding of the situation. For instance, in a medical context, this might include both professional requirements for patient confidentiality and social factors affecting how information should be communicated.

In a step 1140, the system applies structural causal games to model potential decision paths. Based on the research cited in the disclosure, these games help predict how different decisions might affect outcomes, similar to how poker AI evaluates different play strategies. This modeling considers both immediate consequences and potential future implications of different communication strategies.

In a step 1150, the system integrates LLM evaluation of past decisions with current context. Drawing from historical interaction data, the system analyzes how similar situations were handled previously and their outcomes. This includes evaluating the effectiveness of past bluffing strategies and their impact on relationships and trust levels.

In a step 1160, the system generates strategic decision parameters for the bluffing subsystem. These parameters include specific guidance on information disclosure levels, strategic approaches, and boundary conditions. For example, in a negotiation context, this might include specific parameters about which information can be strategically withheld and which must be disclosed for ethical or legal reasons.

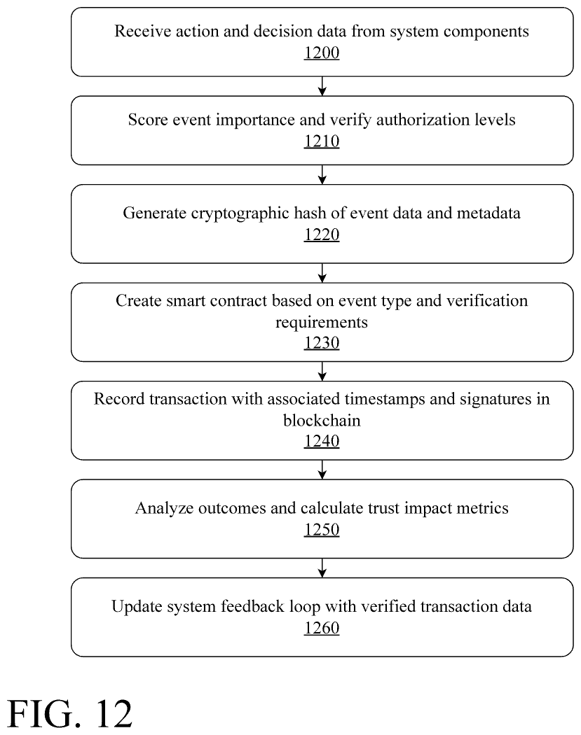

FIG. 12 is a flow diagram illustrating an exemplary method for creating a blockchain leger of past decisions made by AI agents in an agent decision platform. In a first step 1200, the system receives action and decision data from various system components. This includes detailed records of all strategic decisions, bluffing implementations, and their outcomes. For example, in a business negotiation, this might include the specific information disclosure strategies used, timing of disclosures, and immediate counterparty responses.

In a step 1210, the system scores event importance and verifies authorization levels. Each event is evaluated based on factors such as financial impact, relationship significance, and regulatory requirements. For instance, high-stakes negotiations or decisions involving medical privacy might receive higher importance scores and require additional authorization verification.

In a step 1220, the system generates a cryptographic hash of the event data and metadata. This process creates an immutable fingerprint of each decision and action, including contextual information, strategic choices, and outcome data. The hash ensures that records cannot be altered after the fact, providing accountability in professional and regulated contexts.

In a step 1230, the system creates smart contracts based on event type and verification requirements. These contracts automatically enforce role-specific rules and compliance requirements. For example, in medical contexts, smart contracts might ensure HIPAA compliance, while in business contexts, they might enforce disclosure requirements and fiduciary duties.

In a step 1240, the system records transactions with associated timestamps and signatures in the blockchain. Each record includes detailed metadata about who made decisions, when they were made, and under what context. This creates an auditable trail particularly valuable in professional contexts where accountability is important.

In a step 1250, the system analyzes outcomes and calculates trust impact metrics. This includes evaluating how different strategies affected relationship dynamics, trust levels, and strategic objectives. For instance, assessing how specific bluffing strategies impacted long-term business relationships or professional reputation.

In a step 1260, the system updates the feedback loop with verified transaction data. This validated data feeds back into the machine learning training subsystem, enabling continuous improvement of strategic decision-making. The database or blockchain ensures that verified, immutable records are always logged when used for system learning and adaptation. The system includes iterative feedback loops from domain experts, legal counsel, or end users. Throughout negotiations or user interactions, moment-to-moment feedback is appended to the audit logger, along with sensor-derived data capturing counterpart emotional states. These inputs retrain the system's reinforcement learning agents—or otherwise fine-tune the underlying large language models—such that ethically bounded bluffing strategies progressively become more refined. For example, if a user flags an overly aggressive omission as damaging to reputation, the system dynamically lowers its associated reward signal. Such continuous re-optimization, anchored by domain knowledge, ethical constraints, and real-world outcomes, materially extends beyond static poker evaluations or static rule-based protocols. It ensures that the invention evolves in tandem with changing regulations, new organizational policies, or emergent cultural norms, supporting a stable yet adaptive framework for advanced, ethically conscious negotiations.

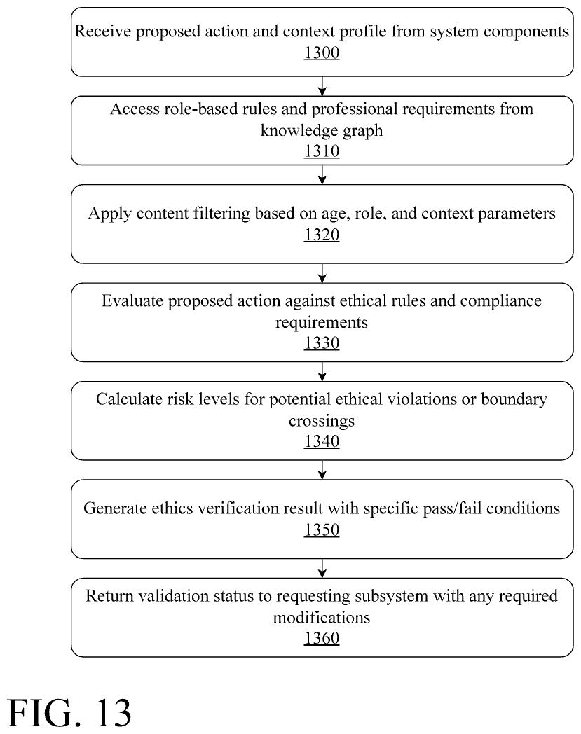

FIG. 13 is a flow diagram illustrating an exemplary method for enforcing ethical boundaries of AI agents in an agent decision platform. In a first step 1300, the system receives proposed actions and context profiles from various system components. This includes potential communication strategies, bluffing proposals, and their intended implementation contexts. For example, when a doctor's AI agent is preparing to respond to a patient inquiry, it receives both the proposed response and the full medical context.

In a step 1310, the system accesses role-based rules and professional requirements from the knowledge graph. This includes retrieving specific ethical guidelines, professional standards, and regulatory requirements applicable to the current situation. For instance, accessing HIPAA requirements for medical professionals, fiduciary duties for executives, or legal obligations for attorneys.

In a step 1320, the system applies content filtering based on age, role, and context parameters. This involves screening proposed communications for appropriateness across multiple dimensions. For example, ensuring age-appropriate content when interacting with minors, or maintaining professional decorum in business contexts while adjusting for cultural sensitivity.

In a step 1330, the system evaluates proposed actions against ethical rules and compliance requirements. This evaluation checks whether strategic communications, including any proposed bluffs or omissions, align with professional responsibilities and ethical boundaries. For instance, ensuring that a financial advisor's strategic communication never crosses the line into misrepresentation of material facts.

In a step 1340, the system calculates risk levels for potential ethical violations or boundary crossings. Using data from previous interactions and established ethical frameworks, it assesses the likelihood and severity of potential ethical issues. This might include evaluating the risk of privacy breaches in medical contexts or assessing potential conflicts of interest in business scenarios.

In a step 1350, the system generates an ethics verification result with specific pass/fail conditions. This result includes detailed reasoning about why certain actions are approved or rejected, with specific references to relevant ethical guidelines or regulatory requirements. For example, explicitly noting when a proposed bluffing strategy would violate professional confidentiality requirements.

In a step 1360, the system returns the validation status to the requesting subsystem with any required modifications. This includes specific guidance on how to adjust rejected strategies to meet ethical requirements. For instance, suggesting alternative approaches that achieve strategic objectives while maintaining professional integrity and ethical compliance.

Some embodiments of the invention incorporate a Hierarchical Ethics Enforcer, employing a two-tier validation mechanism that ensures all strategic bluffs, omissions, or misdirections remain within ethically permissible bounds. In a first tier, specialized compliance microservices (e.g., HIPAA compliance, fiduciary duty constraints) locally verify proposed actions originating from each agent. Subsequently, a global ethics agent or adjudicator aggregates these local validations and performs a higher-level cross-check, referencing an extensible knowledge graph of professional codes, legal statutes, and organizational guidelines. If a bluff or selective omission exceeds prescribed ethical thresholds—such as divulging excessive personal data or misleading in violation of a fiduciary standard—this ethics agent flags or vetoes the proposal. This tiered approach to bluffing governance diverges significantly from standard game-theoretic poker benchmarks, in which bluffing is purely a matter of maximizing expected value without regard to role-based compliance or real-world ethical frameworks.

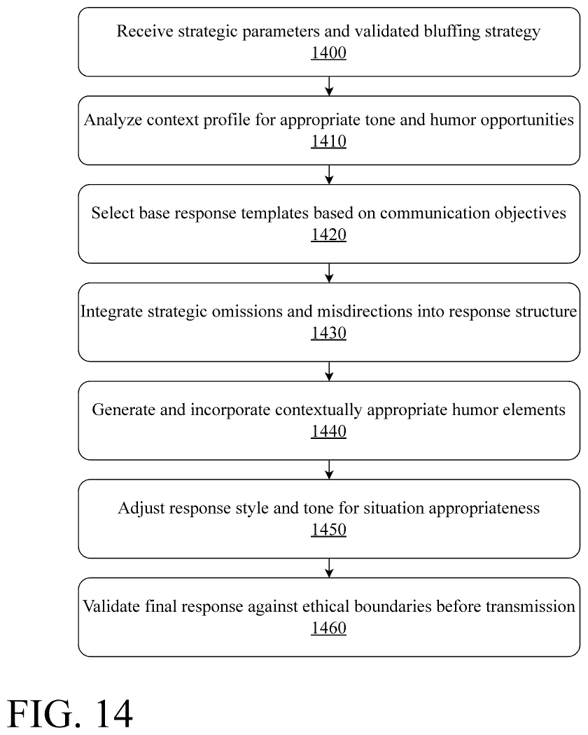

FIG. 14 is a flow diagram illustrating an exemplary method for generating natural language response by AI agents in an agent decision platform. In a first step 1400, the system receives strategic parameters and validated bluffing strategy from previous components. This includes specific guidance on information disclosure levels, strategic objectives, and approved approaches for implementing bluffs or omissions. For example, in a negotiation scenario, this might include approved topics for misdirection and specific information cleared for strategic omission.

In a step 1410, the system analyzes the context profile to determine appropriate tone and identify opportunities for humor integration. Drawing from the disclosure's sections on humor research, the system evaluates whether light jokes might ease tension in negotiations or if witty remarks could maintain social grace during difficult conversations. For instance, assessing whether a humorous observation about timing might soften a declined invitation.

In a step 1420, the system selects base response templates based on communication objectives. These templates provide structural frameworks for different types of communications, from formal business negotiations to casual social interactions. The selection considers factors like relationship dynamics, professional context, and strategic goals.

In a step 1430, the system integrates approved strategic omissions and misdirections into the response structure. This involves carefully crafting language that implements the approved bluffing strategy while maintaining natural conversation flow. For example, artfully redirecting attention in a negotiation or gracefully omitting specific details in a social decline.

In a step 1440, the system generates and incorporates contextually appropriate humor elements. Using principles from the cited humor research, it creates or selects appropriate humorous elements that align with the strategic objectives. This might include subtle wordplay in professional contexts or more casual jokes in social situations, always maintaining appropriate boundaries.

In a step 1450, the system adjusts the response style and tone for situational appropriateness. This includes fine-tuning language formality, emotional warmth, and professional distance based on context. For instance, maintaining warm professionalism in medical communications or appropriate authority in executive communications.

In a step 1460, the system performs a final validation of the response against ethical boundaries before transmission. This ensures that the crafted response, including any humor or strategic elements, remains within approved ethical and professional boundaries. For example, verifying that attempts at lightening the mood don't compromise professional standards or that strategic language doesn't cross into misrepresentation.

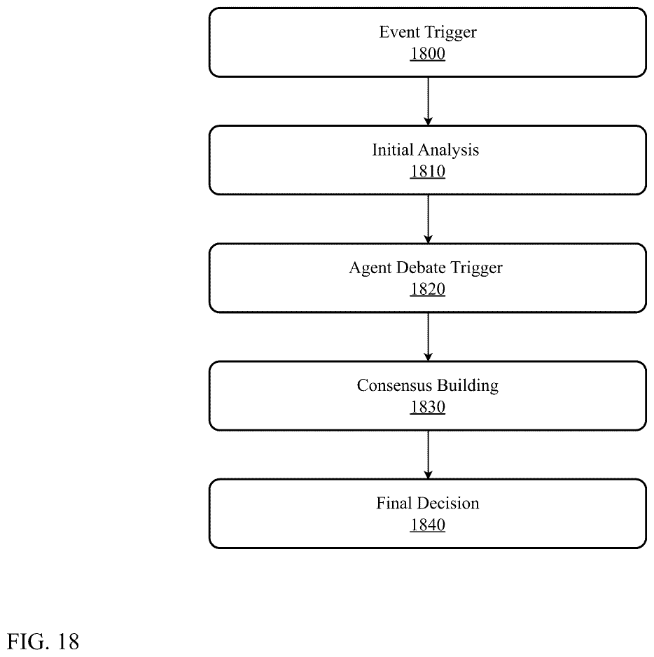

FIG. 18 is a flow diagram illustrating an exemplary method for an internal debate flow that incorporates the approach to AI decision-making that helps surface truth and exposes potential mistakes. In a first step 1800, the event trigger initiates a debate session, whether from a complex negotiation proposal or a significant market shift, the system activates a sophisticated deliberation process that draws upon multiple specialized agents to thoroughly examine the issue from all angles. This approach mirrors recent findings from Anthropic and Google DeepMind, which demonstrated that when AI systems engage in structured debate, they can achieve significantly higher accuracy rates compared to single-agent decision making.

In a step 1810, the initial analysis phase begins by carefully evaluating the situation's scope, priority, and required expertise. During this first step, the system determines which specialist agents should participate based on the specific context, much like how researchers have found that carefully selecting debate participants can significantly impact outcome quality. For instance, in a complex merger negotiation, the initial analysis might identify the need for financial modeling specialists alongside regulatory compliance experts, ensuring all critical perspectives are represented in the subsequent debate.

In a step 1820, the agent debate chamber is where multiple specialized agents engage in structured deliberation through sophisticated interaction protocols. This chamber implements key insights from recent research showing that debate quality improves when agents are specifically trained to be persuasive while maintaining accuracy. The chamber can accommodate any type of specialist agent needed for the context—from traditional roles to highly specialized experts in emerging fields. Each debate follows carefully designed protocols that allow for both direct argumentation and collaborative exploration of ideas, similar to how researchers found that allowing AI systems to choose their debate positions and engage in multiple rounds of discussion led to better outcomes. Within the debate process, agents engage through multiple parallel tracks of discussion, with sophisticated mechanisms to prevent common pitfalls identified in recent research, such as sycophancy bias or undue influence from argument length rather than quality. The system implements safeguards to ensure that decisions are based on strength of reasoning rather than superficial factors like which agent speaks last or how verbosely they argue their position. For example, when evaluating a proposed manufacturing agreement, the system might orchestrate parallel debates about technical feasibility and market timing, while actively monitoring for and correcting any biases in the discussion.

In a step 1830, the consensus building phase represents a critical advancement in collaborative AI decision-making, implementing sophisticated mechanisms for synthesizing various agent perspectives into coherent decisions. This phase draws upon research showing that structured debate processes may help judges (whether human or AI) recognize truth with significantly higher accuracy. The system employs advanced algorithms that weight different viewpoints based on multiple factors, including expertise relevance and historical accuracy, while actively working to mitigate identified challenges such as argument length bias or tendency toward agreement. The following are some specific examples of negotiation/debate frameworks that may be employed. The framework for any particular case may be dictated by the users, however the platform should also identify a default or recommended selection based on the type of case and agents chosen. Agents can be trained on a range of different frameworks or primarily focus on one or more based as decided by the user creating the agent. This may be adapted in the future via continuous learning, but for this reason the choice of debate/negotiation framework must take into account the agents chosen for representation. In Adversarial (Two-Party) Negotiation, two Primary Agents/Parties negotiate directly, with no third-party involvement unless an impasse is reached. The goal is to reach a mutually beneficial outcome based on predefined preferences. This includes variants such as Fixed-Sum (Zero-Sum) Negotiation, where one party's gain is the other party's loss, and Win-Win (Interest-Based) Negotiation, where both parties aim for Pareto-optimal agreements. Example use cases include business contract negotiations (e.g., supplier-vendor pricing) and diplomatic treaty discussions between two nations. For Arbitrator-Mediated Negotiation, two negotiating parties present their cases while a neutral arbitrator listens, evaluates, and makes a binding decision. The arbitrator may suggest compromises but ultimately enforces a resolution. This approach ensures a decision is reached even in a deadlock and reduces power imbalances by enforcing fairness. Example use cases include legal dispute resolutions and labor union negotiations. In Mediation (Facilitator-Led), two or more negotiating parties communicate through a neutral mediator who does not impose a decision but helps facilitate discussion, focusing on collaboration and voluntary compromise. This approach encourages open communication and preserves relationships by avoiding adversarial interactions. It's particularly useful in conflict resolution in organizations and family law mediation. Judge-Based Adjudication employs a single judge who listens to both sides and renders a final ruling, following predefined laws, regulations, or ethical principles. This ensures clear accountability and legal compliance, working well when precedents and objective rules apply, such as in patent dispute settlements and AI-driven legal contract enforcement. The Panel of Judges (Tribunal Model) involves three or more judges evaluating the negotiation, voting on the best resolution or deliberating collectively. This reduces bias by having multiple decision-makers and brings specialist expertise into the evaluation process, making it suitable for international trade disputes and sports arbitration cases. Deliberative Panel (Public Consultation Model) features a diverse panel of stakeholders or representatives debating key issues, with decisions made through consensus-building or voting. This ensures broad representation of interests and avoids authoritarian decision-making, particularly useful in AI ethics advisory boards and community-led city planning. Auction-Based Negotiation follows a market-driven approach where negotiation occurs in a bidding format with agents proposing prices/offers, either openly or sealed. This maximizes economic efficiency by letting market dynamics determine the outcome, commonly used in real estate auctions and AI-driven procurement contracts. The Delphi Method employs iterative consensus where multiple experts provide independent opinions on a negotiation issue, which are collected, aggregated, and refined over multiple rounds. This removes groupthink by ensuring independent expert input, particularly valuable in AI policy frameworks and corporate strategy planning. Finally, Hybrid Models combine multiple formats based on the negotiation context, such as moving from Mediation to Arbitration to Final Judgment. These are particularly useful in international conflict resolution and corporate mergers and acquisitions.

Next we provide some additional exemplary capabilities and enhancements that integrate the concept of hyperparameter-tuned “LLM Judges” (drawing on the recent work by Salinas, Swelam, and Hutter on multi-objective optimization) into the AI bluffing and strategic omission platform. These additions further refine the decision-making, ethical validation, and evaluative feedback loops within multi-agent negotiations, particularly where real-world constraints (e.g., time, resources, legal compliance) require cost-efficient and highly accurate judgments:

### 1. LLM Judge Agents With Multi-Fidelity Optimization

In addition to the existing ethics enforcer and multi-agent debate system, the platform may incorporate specialized “Judge Agents” that evaluate the quality and appropriateness of an AI agent's bluffing, omissions, and disclosures. These Judge Agents, which themselves are LLM-based, can be tuned via a multi-fidelity, multi-objective optimization pipeline analogous to that outlined by Salinas et al. This enables the system to rapidly iterate through possible judge configurations—varying prompt templates, model sizes, temperatures, or chain-of-thought transparency—by first testing them on smaller or cheaper datasets (fewer negotiation samples or simpler contexts) and then promoting the most promising judge hyperparameters to higher-fidelity evaluations using more complex or costly scenarios. By optimizing for multiple objectives (e.g., alignment with human feedback, ethical compliance rates, or trust metrics), the system can settle on a final LLM Judge configuration that most closely matches the platform's real-world success criteria.

### 2. Adaptive Judge Consensus for Ethical and Strategic Scoring

Once these Judge Agents are tuned and embedded into the negotiation loop, the platform can employ a “consensus integration” step. Multiple specialized judges (one focusing on compliance, another on user satisfaction, another on negotiation efficacy) each produce an initial verdict on whether a proposed bluff, omission, or misdirection is both strategic and ethically sound. The system then aggregates or fuses these verdicts using multi-objective weighting schemes refined by historical performance data. This method parallels the notion of “Human Agreement” as a robust metric from the tuning research, but applies it to a multi-agent environment: if the judges disagree, a structured debate or re-optimization is triggered, incrementally refining both the negotiating agents'tactics and the Judge Agents'scoring heuristics.

### 3. Cost-Efficient Evaluation and Live Deployments

Just as Salinas et al. reduced tuning costs from millions to thousands of dollars using multi-fidelity approaches, the invention can leverage similar strategies to make real-time or iterative negotiation oversight more feasible. For early-stage or low-stakes negotiations, the platform can rely on cheaper, smaller-scale LLM Judges or fewer sensors to quickly assess agent outputs. If a negotiation escalates in complexity or monetary value—e.g., major M&A deals or sensitive legal contexts—the system seamlessly transitions to a higher-fidelity Judge Agent that uses more computationally expensive inference parameters or deeper contextual analysis. By dynamically selecting the level of fidelity, the platform ensures that multi-agent negotiations remain both cost-effective and thoroughly audited.

### 4. Refined Metrics: Human-Like Agreement & Advanced Scoring

Finally, the platform can adopt refined scoring techniques—akin to Spearman correlation or “Human Agreement”—to measure how closely the Judge Agents'evaluations track the actual preferences of human stakeholders, regulators, or domain experts. In critical contexts such as healthcare or financial services, the system can store “gold standard” human judgments in its knowledge graph. Over time, the platform's Judge Agents incrementally tune or calibrate themselves against these reference judgments. This continuous feedback loop, implemented via a multi-objective hyperparameter search, ensures that as the system refines its bluffing behaviors, it also maintains the highest possible fidelity to professional, ethical, and user-aligned standards, even under the distribution shifts common to real-world negotiations.

In a step 1840, the final decision output phase produces not just a decision, but a comprehensive explanation of the reasoning process, addressing a key challenge identified in recent research—the need for transparency and verifiability in AI decision-making. This output includes detailed documentation of the debate process, including dissenting viewpoints and alternative scenarios considered, providing crucial context for understanding how the system arrived at its conclusions. This approach helps address concerns about AI systems becoming “superhuman” in certain domains by ensuring their decision-making process remains transparent and auditable.

Throughout the entire process, the system maintains sophisticated learning mechanisms that continuously improve its debate and decision-making capabilities. This aligns with research findings showing that AI systems can be trained to become increasingly effective at both participating in and judging debates. The system carefully balances the need for persuasive argumentation with strict adherence to truth and accuracy, implementing safeguards against potential manipulation or bias while maintaining professional standards throughout all interactions.

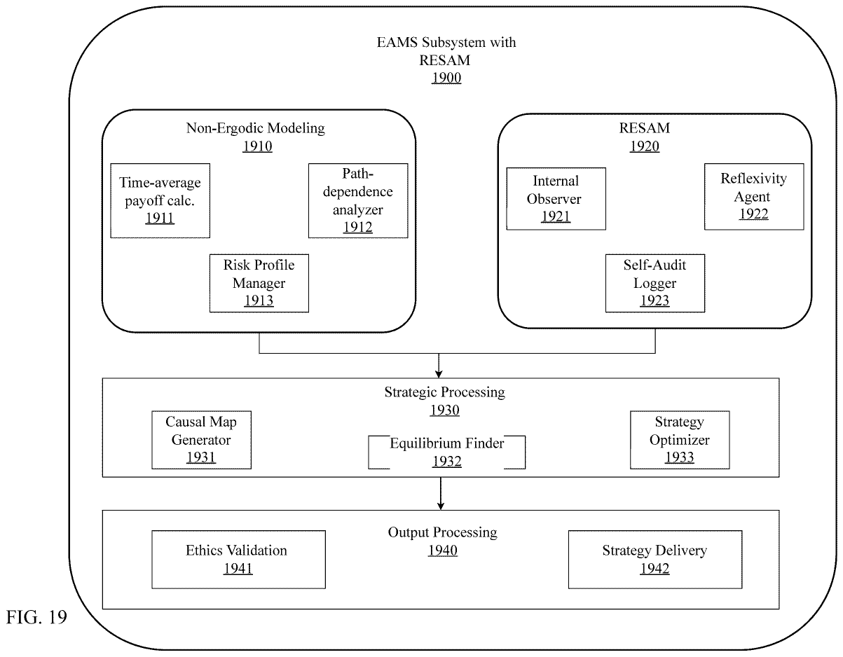

FIG. 19 illustrates the ergodicity-aware modeling and signaling (EAMS) subsystem 1900 with its integrated reflexivity-enhanced self-audit mechanism (RESAM). Unlike standard game-theoretic approaches that rely on ensemble-average utilities, this subsystem accounts for non-ergodic dynamics—specifically the time-average growth or survival probability of each participant in high-stakes or repeated interactions. Research in ergodic economics and evolutionary simulations shows that parties exhibit risk-aversion not due to arbitrary “biases” but because time-based returns deviate significantly from ensemble averages.

The Non-Ergodic Modeling section 1910 implements core ergodicity-aware analysis through three components. The Time-Average Payoff Calculator 1911 tracks each counterparty's wealth or utility trajectory in multiplicative-gain environments, determining tolerance for omissions, partial truths, or aggressive tactics. The Path-Dependence Analyzer 1912 identifies potential absorbing boundaries (e.g., bankruptcy, legal liability, social fallout) that drastically alter behavior. The Risk Profile Manager 1913 combines domain-specific risk thresholds, prior negotiation outcomes, and real-time sensor/market data indicative of performance volatility. This component also incorporates Bayesian inference steps for adaptive encoding/decoding using the speaker-listener framework, forming a joint signaling game that factors in time-average growth signals.

The RESAM section 1920 captures the phenomenon wherein an AI agent's interventions dynamically reshape the negotiation environment. The Internal Observer 1921 continuously monitors changes in sensor data, user feedback, and counterparties'behavior to identify “reflexive events” where the AI's prior actions have altered the environment's future trajectory. For example, if repeated bluffing maneuvers prompt a counterparty to raise confidentiality requirements, this is automatically flagged as a reflexive feedback loop. The Reflexivity Agent 1922 conducts continual critique of proposed strategies, leveraging symbolic rules and knowledge graph entries related to “self-generated context changes” (e.g., forced legal review, heightened oversight, accelerated mistrust). The Self-Audit Logger 1923 records reflexive events into an immutable ledger along with annotations describing how agent actions reshaped payoff distributions.

The Strategic Processing section 1930 generates optimal strategies through three sophisticated engines. The Causal Map Generator 1931 employs neuro-symbolic causal reasoning and signaling game theory from emergent semantic communications research to infer a contextual causal map of each counterparty's payoffs. It uses a generative model (e.g., GFlowNet variant) and encodes symbolic constraints through logical neural networks that capture known regulatory, financial, and personal constraints. The Equilibrium Finder 1932 implements a specialized optimization routine to locate “partial pooling” or “pooling-separating” equilibria that factor in time-average growth signals, while incorporating the speaker-listener framework for adaptive encoding/decoding in message generation. The Strategy Optimizer 1933 uses a signaling equilibrium approach inspired by emergent semantic communication to propose minimal yet semantically rich messages that exploit each counterparty's dynamic risk weighting, ensuring message structure aligns with causal drivers behind counterparties'time-based survivability or utility.

The Output Processing section 1940 ensures alignment with system requirements. The Ethics Validation component 1941 supports Ethical and Professional Reflexivity, automatically recognizing when the AI's actions trigger new oversight rules or ethical mandates. For instance, if the system's partial misdirection raises concerns about misinformation, all specialized agent teams (legal, compliance, ethics) re-validate the permissible range of bluffing behaviors through direct integration with the knowledge graph. The Strategy Delivery component 1942 can proactively propose disclaimers or alternative negotiation styles once it detects that reflexive changes have significantly raised reputational or legal risks, maintaining a continuous feedback loop between emergent environmental constraints and the system's internal decision boundaries.

At a deeper level, this architecture acknowledges that the AI agent becomes a co-creator of the environment's subsequent states in truly non-ergodic social or economic domains, moving beyond traditional game-theoretic models that presume a static environment where only exogenous moves matter. The system continuously recalculates time-average growth and survival probabilities whenever reflexive events occur, ensuring all path-dependent outcomes incorporate the agent's contributions to shifting negotiation dynamics. This synergy of reflexivity and non-ergodicity captures the authentic complexity of human-involved negotiations: path-dependent phenomena, hidden feedback loops, adaptive shifts in stakeholder trust, and continuously evolving ethical and legal constraints.

Through this sophisticated architecture, the EAMS subsystem with RESAM achieves higher fidelity to real-world organizational dynamics than conventional AI negotiation tools. By integrating emergent semantics, causal structures, and ergodic modeling under a single platform, while systematically identifying, recording, and adapting to self-authored changes and maintaining strict ethical boundaries, the system delivers more stable, trust-preserving outcomes in high-stakes scenarios. The architecture significantly improves the robustness and realism of AI-driven negotiations by addressing path-dependent risk behaviors often observed in real human or organizational stakeholders.

In one embodiment, the invention is enhanced with a specialized Ergodicity-Aware Modeling and Signaling (EAMS) Subsystem that refines strategic interactions between the bluffing AI agent(s) and each counterparty. Unlike standard game-theoretic approaches, which often rely on ensemble-average utilities or simplified expected value calculations, EAMS accounts for non-ergodic dynamics—that is, the time-average growth or survival probability of each participant. This approach pulls from recent research in ergodic economics and evolutionary simulations showing that, in high-stakes or repeated interactions, parties exhibit risk-aversion not because of arbitrary “biases” but because time-based returns deviate significantly from ensemble averages. Accordingly, EAMS tracks each counterparty's wealth or utility trajectory in a multiplicative-gain or otherwise non-ergodic environment to determine their tolerance for omission, partial truths, or aggressive tactics. By modeling the path-dependent consequences for each party, the system can dynamically fine-tune bluffs or disclosures in ways that align with real-world risk perceptions and that better predict how (and why) counterparties respond under genuine non-ergodic conditions.

To achieve this, the invention incorporates neuro-symbolic causal reasoning and signaling game theory from emergent semantic communications research. Specifically, when the AI agent contemplates a bluff or strategic omission, the EAMS subsystem first infers a contextual causal map of each counterparty's payoffs using a generative model (e.g., GFlowNet variant) and encodes symbolic constraints (logical neural networks) that capture known regulatory, financial, or even personal constraints. Simultaneously, it calculates each party's “time-average payoff” trajectory in repeated or sequential interactions, identifying potential absorbing boundaries (e.g., bankruptcy, legal liability, social fallout) that drastically alter behavior. The system then uses a signaling equilibrium approach—inspired by emergent semantic communication—to propose minimal yet semantically rich messages that exploit each counterparty's dynamic risk weighting. By aligning message structure (or bluff content) with the causal drivers behind counterparties'time-based survivability or utility, the agent can more accurately predict if selective misdirection will be accepted, rejected, or cause an escalatory response.

Technically, the EAMS subsystem operates as follows. First, it retrieves or infers each counterparty's non-ergodic payoff model from the knowledge graph, including domain-specific risk thresholds, prior negotiation outcomes, and real-time sensor/market data indicative of performance volatility. Next, it combines these payoff models with the agent's own constraints and objectives, forming a joint signaling game with Bayesian inference steps for adaptive encoding/decoding (e.g., the speaker-listener framework). A specialized optimization routine then locates a “partial pooling” or “pooling-separating” equilibrium that factors in time-average growth signals. Finally, the EAMS subsystem passes recommended strategic moves (e.g., which partial truths to withhold, how to phrase potential misdirection) to the ethics enforcer and multi-agent debate layer, ensuring that the final message or tactic remains within role-based legal and ethical constraints. By integrating emergent semantics, causal structures, and ergodic modeling under a single platform, the invention significantly improves the robustness and realism of AI-driven negotiations, surpassing standard bluffing engines that fail to address path-dependent risk behaviors often observed in real human or organizational stakeholders.

In an another embodiment, the system integrates reflexivity within its ergodicity-aware modeling to capture the phenomenon wherein an AI agent's own interventions dynamically reshape the negotiation or decision environment over time. By reflexivity, we refer to the continuous and self-reinforcing feedback loop in which the system's outputs change counterparty perspectives, operational constraints, or even regulatory conditions, which in turn feed back into subsequent system choices. In standard non-ergodic approaches, path-dependent payoffs are calculated under assumptions that a party's internal state evolves solely from exogenous events and prior decisions. However, this invention expressly acknowledges that the AI platform itself is not a neutral observer but rather an active agent whose disclosures, omissions, and strategic maneuvers can alter the very probability distributions and contextual factors the system is attempting to model. Consequently, we embed a Reflexivity-Enhanced Self-Audit Mechanism (RESAM) alongside the existing Ergodicity-Aware Modeling and Signaling (EAMS) subsystem to detect, log, and adapt to the ways in which agent-driven outputs shift the environment's risk and payoff landscape for all parties, including the AI's own “position” in the negotiation architecture.

More concretely, RESAM operates through an Internal Observer module that continuously monitors changes in sensor data, user feedback, and counterparties'behavior to identify “reflexive events” in which the AI's prior actions plausibly altered the environment's future trajectory. As an illustration, if repeated bluffing maneuvers or partial disclosures prompt a counterparty to raise confidentiality requirements or adopt more conservative risk thresholds, RESAM automatically flags these as reflexive feedback loops. In doing so, the system tracks not only how the AI's strategic behavior influences a single negotiation stage but also how those strategic choices might shape future steps (or even future negotiations with the same party) under the lens of time-average (non-ergodic) evolution. The path-dependence updater embedded in EAMS then re-computes each participant's risk profile, adjusting the model to reflect that the previously used bluffing style has meaningfully changed the conditions under which counterparties will act—thereby recalibrating expected time-average payoffs, newly emergent constraints, and updated game-theoretic equilibria.

In parallel, a specialized “Reflexivity Agent” in the multi-agent debate layer conducts continual critique of any proposed strategies or disclosures, questioning whether the AI's own output might trigger self-defeating or self-reinforcing patterns. For instance, the Reflexivity Agent leverages symbolic rules and prior knowledge graph entries related to “self-generated context changes”—an entry type that encodes known outcomes of reflexive loops (e.g., forced legal review, heightened oversight, accelerated mistrust). By referencing these rules, the Reflexivity Agent can block or modify certain bluffing tactics if it determines that using them repeatedly would degrade long-term trust or produce compliance violations. Furthermore, any reflexive effects discovered by the Reflexivity Agent are fed back to the Self-Audit Logger, a component that records reflexive events into an immutable ledger—such as a blockchain or similarly tamper-proof database—along with annotations describing how the agent's own actions reshaped the environment's payoff distributions. This reflexive audit ensures that subsequent fine-tuning of the system's negotiation or decision policies takes into account historical instances when the AI effectively “moved the goalposts” for itself and for others.

Critically, this reflexivity mechanism also supports what we term Ethical and Professional Reflexivity, a process by which newly emergent social, legal, or policy constraints resulting from the AI's own communications are automatically recognized. Whenever reflexive events indicate that fresh oversight rules or revised ethical mandates have been imposed—perhaps because the AI's partial misdirection raised concerns about misinformation—the invention's knowledge graph is updated accordingly, and all specialized agent teams (e.g., legal, compliance, ethics) re-validate the agent's permissible range of bluffing or data concealment. By maintaining a continuous feedback loop between the environment's emergent constraints and the system's internal decision boundaries, the reflexivity layer reduces hidden conflicts and unintended consequences. The system can, for example, proactively propose disclaimers or alternative negotiation styles once it detects that reflexive changes have significantly raised the risk of reputational damage or legal blowback.

At a deeper level, reflexivity is essential for capturing truly non-ergodic social or economic domains where the “state space” is jointly constructed by human actors and by their evolving interpretations of the AI's role. Traditional game-theoretic models often presume a static environment in which only exogenous moves by each party matter. By contrast, this invention integrates reflexivity to acknowledge that the AI agent becomes a co-creator of the environment's subsequent states, and thus must adapt its strategy to the new realities it has partially created. The EAMS subsystem, originally tasked with computing time-average growth or survival probabilities for each participant, is thus extended to recalculate these probabilities whenever a reflexive event is logged, ensuring that all path-dependent outcomes explicitly incorporate the agent's contributions to shifting these paths. This synergy of reflexivity and non-ergodicity yields a more robust and ethically grounded system, as it captures the authentic complexity of human-involved negotiations: path-dependent phenomena, hidden feedback loops, adaptive shifts in stakeholder trust, and continuously evolving ethical or legal constraints.

In sum, the reflexivity-enhanced embodiment surpasses conventional “AI negotiation” tools by systematically identifying, recording, and adapting to the system's self-authored changes in the environment. The Internal Observer flags real-time reflexive feedback loops, while the path-dependence updater recalculates non-ergodic payoffs, and the Reflexivity Agent debates strategic proposals to forestall damaging cycles. The entire approach is anchored by an immutable reflexive audit trail and updated knowledge graph entries that codify emergent constraints. Through this reflexive extension, the invention achieves a higher fidelity to real-world organizational dynamics, fosters transparency in how AI agents shape negotiations, and ultimately delivers more stable, trust-preserving outcomes in high-stakes scenarios.

### Exemplary Computing Environment

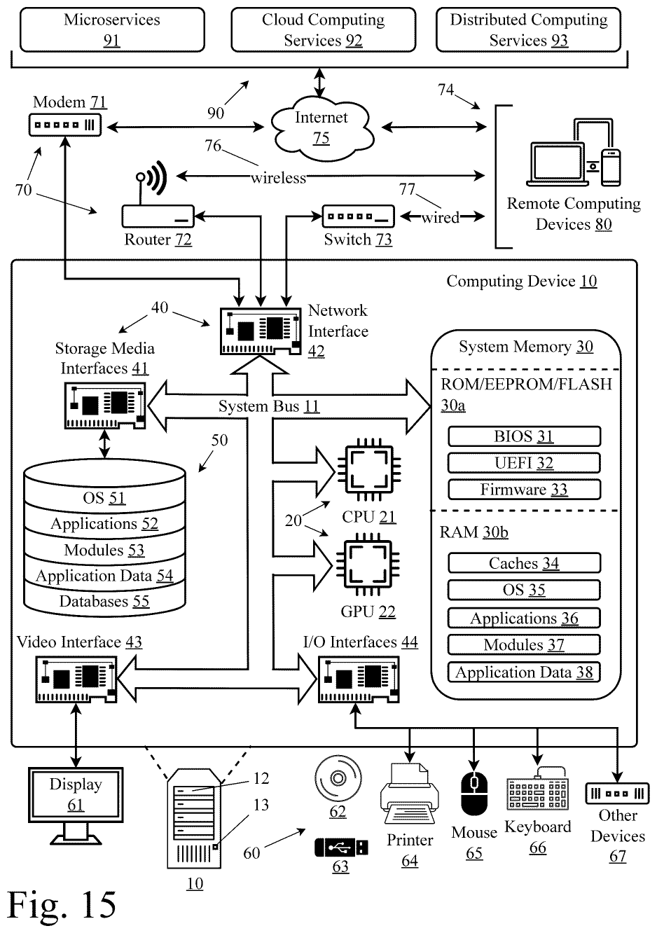

FIG. 15 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

In some embodiments, the disclosed AI agent decision platform is adapted for quantum-secure communications and negotiations, ensuring confidentiality and strategic advantage in environments vulnerable to quantum-based attacks. For instance, quantum photonic chips may be integrated within or interfaced to the system to enable secure multi-agent coordination and bluffing maneuvers over quantum channels. These quantum photonic chips—constructed using silicon-on-insulator (SOI), silicon nitride (Si₃N₄), or other hybrid material platforms—may facilitate the transmission or receipt of quantum-encrypted messages that are inherently tamper-evident. Such photonic integration permits large-scale production of on-chip quantum key distribution (QKD) modules, allowing the AI agents to exchange cryptographic keys with guaranteed security against both classical and quantum computational threats. In a negotiation scenario, each party's AI agent can employ on-chip single-photon detectors (e.g., superconducting nanowire SPDs) and integrated quantum light sources (e.g., spontaneous four-wave mixing or quantum dots) to establish a QKD link prior to initiating high-stakes discussions, thereby preserving trust and verifying authenticity even if an adversarial party or observer possesses quantum computational resources.

Once quantum-encrypted channels are established, the agent decision platform can incorporate specialized QKD protocols—such as discrete-variable QKD (DV-QKD) or measurement-device-independent QKD (MDI-QKD)—to ensure that sensitive terms, strategic omissions, or bluffing signals are exchanged securely. These protocols mitigate standard vulnerabilities by leveraging entangled photon pairs or single-photon transmissions, thereby ensuring resilience against eavesdropping or interception. In embodiments involving multi-agent negotiations, the same infrastructure may be extended to broadcast quantum-secure signals across numerous nodes, effectively creating a “quantum internet” layer undergirding all agent communications. This not only guarantees message confidentiality but also enhances the reliability of strategic maneuvers, as quantum protocols allow rapid detection of unauthorized measurement attempts or forced disclosure.

Additionally, certain embodiments employ hybrid classical-quantum simulation techniques to validate negotiation or bluffing tactics offline before deploying them in live quantum-secure environments. Drawing on frameworks akin to “HybridQ,” the system can simulate quantum state vectors (for smaller negotiations that only require moderate qubit counts) or can utilize tensor network contractions for more extensive multi-party interactions (exceeding 50-100 qubits). By integrating quantum-specific noise modeling—such as depolarizing channels or amplitude damping—the agent platform is able to pre-empt vulnerabilities and refine its bluffing and omission strategies under realistic quantum error conditions. In one example, the system's machine learning training subsystem orchestrates classical HPC resources and GPU-or TPU-based backends to test how small amounts of quantum noise or partial decoherence might alter the perceived credibility of a bluff. These insights then inform real-time agent decisions as negotiations proceed across quantum-secure channels, balancing secrecy, reliability, and ethical constraints.

In this manner, the AI agent decision platform extends beyond classical secure channels into fully quantum-safe embodiments, harnessing the core advantages of quantum photonic chips (scalability, stability, ultra-low-loss waveguides), integrated QKD modules, and advanced hybrid simulation frameworks. The platform thereby furnishes sophisticated negotiation tools resilient against next-generation computational threats—quantum or otherwise—and provides a robust multi-agent architecture adaptable to enterprise, governmental, or cross-border contexts where both strategic bluffing and unassailable encryption are paramount.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ 45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computing system for AI agents with strategic interaction and bluffing capabilities in an agent decision platform, the computing system comprising:
one or more hardware processors configured for:
receiving and analyzing multimodal inputs;
evaluating multiple contexts to generate a context profile;
determining an appropriate information disclosure strategy;
training machine learning models on strategic interaction approaches;
generating responses that include bluffs or omissions;
integrating contextually appropriate humor;
validating responses against defined boundaries;
generating immutable records of decisions and outcomes;
transmitting validated responses to users; and
wherein the system optionally operates in a multi-agent mode through distributed teams of specialized agents.

2. The computing system of claim 1, further comprising:
a validation subsystem including a rules engine implementing core ethical principles and professional based on information stored in a knowledge graph;
a content filter screening communications against professional standards and social norms;
an authorization checker verifying actions within permission boundaries; and
wherein the validation subsystem optionally operates in a multi-agent mode comprising specialized agents, peer review capabilities, and consensus integration.

3. The computing system of claim 2, wherein the knowledge graph comprises:
domain expertise, optionally interconnected across specialist agents;
domain-specific information structured as semantic relationships and rules;
professional standards and ethical frameworks, optionally shared across agents;
regulatory requirements and compliance guidelines;
learning from interactions, optionally including collaborative team learning;
social and professional norms, optionally updated through agent debate; and
relationship mapping for decision support, optionally including cross-domain mapping.

4. The computing system of claim 1, wherein generating a context profile optionally through multi-agent collaboration comprises:
mapping relationship dynamics in social networks;
evaluating regulatory requirements based on professional roles;
assessing market conditions, optionally through multi-agent data analysis;
calculating privacy sensitivity levels;
validating context interpretation, optionally across agents.

5. The computing system of claim 1, wherein operating in multi-agent mode comprises:
a negotiation interface coordinating agent interactions;
multiple specialized agents performing different roles;
inter-agent communication protocols;
team-based debate decision-making processes;
collaborative validation mechanisms; and
dynamic agent deployment based on context requirements.

6. A computer-implemented method for AI agents with strategic interaction and bluffing capabilities in an agent decision platform, the computer-implemented method comprising:
receiving and analyzing multimodal inputs;
evaluating multiple contexts to generate a context profile;
determining an appropriate information disclosure strategy;
training machine learning models on strategic interaction approaches;
generating responses that include bluffs or omissions;
integrating contextually appropriate humor;
validating responses against defined boundaries;
generating immutable records of decisions and outcomes;
transmitting validated responses to users; and
wherein the system optionally operates in a multi-agent mode through distributed teams of specialized agents.

7. The computer-implemented method of claim 6, further comprising:
a validation subsystem including a rules engine implementing core ethical principles and professional based on information stored in a knowledge graph;
a content filter screening communications against professional standards and social norms;
an authorization checker verifying actions within permission boundaries; and
wherein the validation subsystem optionally operates in a multi-agent mode comprising specialized agents, peer review capabilities, and consensus integration.

8. The computer-implemented method of claim 7, wherein the knowledge graph comprises:
domain expertise, optionally interconnected across specialist agents;
domain-specific information structured as semantic relationships and rules;
professional standards and ethical frameworks, optionally shared across agents;
regulatory requirements and compliance guidelines;
learning from interactions, optionally including collaborative team learning;
social and professional norms, optionally updated through agent debate; and
relationship mapping for decision support, optionally including cross-domain mapping.

9. The computer-implemented method of claim 6, wherein generating a context profile optionally through multi-agent collaboration comprises:
mapping relationship dynamics in social networks;
evaluating regulatory requirements based on professional roles;
assessing market conditions, optionally through multi-agent data analysis;
calculating privacy sensitivity levels;
validating context interpretation, optionally across agents.

10. The computer-implemented method of claim 6, wherein operating in multi-agent mode comprises:
a negotiation interface coordinating agent interactions;
multiple specialized agents performing different roles;
inter-agent communication protocols;
team-based debate decision-making processes;
collaborative validation mechanisms; and
dynamic agent deployment based on context requirements.

11. A system for AI agents with strategic interaction and bluffing capabilities in an agent decision platform, cause the system to:
receive and analyze multimodal inputs;
evaluate multiple contexts to generate a context profile;
determine an appropriate information disclosure strategy;
train machine learning models on strategic interaction approaches;
generate responses that include bluffs or omissions;
integrate contextually appropriate humor;
validate responses against defined boundaries;
generate immutable records of decisions and outcomes;
transmit validated responses to users; and
wherein the system optionally operates in a multi-agent mode through distributed teams of specialized agents.

12. The system of claim 11, further comprising:
a validation subsystem including a rules engine implementing core ethical principles and professional based on information stored in a knowledge graph;
a content filter screening communications against professional standards and social norms;
an authorization checker verifying actions within permission boundaries; and
wherein the validation subsystem optionally operates in a multi-agent mode comprising specialized agents, peer review capabilities, and consensus integration.

13. The system of claim 12, wherein the knowledge graph comprises:
domain expertise, optionally interconnected across specialist agents;
domain-specific information structured as semantic relationships and rules;
professional standards and ethical frameworks, optionally shared across agents;
regulatory requirements and compliance guidelines;
learning from interactions, optionally including collaborative team learning;
social and professional norms, optionally updated through agent debate; and
relationship mapping for decision support, optionally including cross-domain mapping.

14. The system of claim 11, wherein generating a context profile optionally through multi-agent collaboration comprises:
mapping relationship dynamics in social networks;
evaluating regulatory requirements based on professional roles;
assessing market conditions, optionally through multi-agent data analysis;
calculating privacy sensitivity levels;
validating context interpretation, optionally across agents.

15. The system of claim 11, wherein operating in multi-agent mode comprises:
a negotiation interface coordinating agent interactions;
multiple specialized agents performing different roles;
inter-agent communication protocols;
team-based debate decision-making processes;
collaborative validation mechanisms; and
dynamic agent deployment based on context requirements.
